(19) United States
(12) Patent Application Publication
(10) Pub. No.: US 2025/0345711 A1
(43) Pub. Date: Nov. 13, 2025

(54) METHOD AND SYSTEM

(71) Applicant: COVER Corp., Tokyo (JP)

(72) Inventor: Ryohei UEDA, Tokyo (JP)

(21) Appl. No.: 19/241,377

(22) Filed: Jun. 18, 2025

Related U.S. Application Data
(63) Continuation of application No. PCT/JP2023/046119, filed on Dec. 22, 2023.

(30) Foreign Application Priority Data
Dec. 23, 2022 (JP) 2022-207190

(51) Int. Cl. A63F 13/79; A63F 13/35; H04L 67/131

(52) U.S. Cl. CPC A63F 13/79; A63F 13/35; H04L 67/131

(57) ABSTRACT

During distribution of any of first modes of content, if it is determined that no SP user is participating in a virtual space of the content, and even if the posted comment includes a NG word set for any SP user, the received comment is reflected in the virtual space. In contrast, during distribution of any of first modes of content, if it is determined that a SP user is participating in a virtual space of the content (including the case where a SP user, who was not participating, is participating there), and if the posted comment includes a NG word set for the SP user who is participating, reflection of the received comment in the virtual space is restricted.

### CROSS-REFERENCE TO RELATED APPLICATIONS

This application claims the benefit of priority and is a Continuation application of the prior International Patent Application No. PCT/JP2023/046119, with an international filing date of Dec. 22, 2023, which designated the United States, and is related to the Japanese Patent Application No. 2022-207190, filed Dec. 23, 2022, the entire disclosures of all applications are expressly incorporated by reference in their entirety herein.

### BACKGROUND

### 1. Technical Field

The present invention relates to methods and systems.

### 2. Description of the Background

A known system for distributing content via a network includes one that distributes a video in which a virtual character (avatar) appears in a virtual space and acts in response to the distributor. Another known system reflects comments and other actions received from viewers watching a video distributed in a virtual space, but limits or restricts the reflection of some actions that the distributor has set as undesirable (see, for example, Patent Literature 1).

### CITATION LIST

### Patent Literature

Patent Literature 1: JP 2020-17950 A

### BRIEF SUMMARY

The conventional systems, however, restrict the reflection of actions that a distributor has set as undesirable in the virtual space in which the distributor initiatively distributes. This means that the system does not cover the restrictions in a virtual space where the distributor does not initiatively distribute. For instance, when a distributor joins just as a viewer or in the middle of the distribution, the actions set may not be properly restricted but reflected.

In views of the above, the present invention provides a method and a system that properly restrict a set action.

(1) A method that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) for whom an action to be restricted is configurable, the action to be restricted being an action whose reflection is restricted (e.g., a NG word),
the method comprising a step of, in a first situation where the specific user is not included in the plurality of users having the specific relationship (e.g., during distribution of a first mode of content, NO in step S15 of FIG. 8), even when the action to be restricted is received from one of the plurality of computers, performing a process of reflecting the action to be restricted on the plurality of computers (e.g., step S20 of FIG. 8), and when a situation changes from the first situation to a second situation where the specific user is included (e.g., during distribution of a first mode of content, YES in step S15 of FIG. 8), and when the action to be restricted is received from one of the plurality of computers, performing a process of restricting reflection of the action to be restricted (e.g., YES in step S17 of FIG. 8).

With this configuration, the action to be restricted is reflected in the first situation, whereas reflection of the action to be restricted is restricted after the situation changes from the first situation to the second situation. This enables appropriate restriction of the reflection of the action to be restricted, depending on whether the specific user is included.

(2) The above (1) comprises:
a step of updating a history of actions received from the plurality of computers operated by the plurality of users having the specific relationship (e.g., step S19 of FIG. 8); and
a step of, when a new user becomes included in the plurality of users having the specific relationship, outputting history information that enables identification of the history of actions updated by the updating step to a computer operated by the new user (e.g., step S12 of FIG. 8), in which
when the new user is the specific user and a situation changes from the first situation to the second situation, and when the history of actions includes an action to be restricted, the updating step enables updating so that the history of actions includes actions other than the action to be restricted (e.g., step S13 of FIG. 8).

When the situation changes to the second situation, this configuration prevents reflection of the history of actions including the action to be restricted on the computer of the specific user.

(3) In the above (2), the action to be restricted includes an action belonging to a first type and an action belonging to a second type, and in the updating step, when the new user is the specific user and a situation changes from the first situation to the second situation, the history of actions is updated so as to include an action belonging to the first type, and not to include an action belonging to the second type (see (1) in <Modification Examples>).

When the situation changes to the second situation, this configuration makes it possible to more precisely determine whether to reflect or restrict an action, depending on the type of the action to be restricted.

(4) In the above (2), when the new user is the specific user and the situation changes from the first situation to the second situation, the outputting step outputs history information that enables identification of the history of actions that has been updated by the updating step to the computer operated by the specific user (e.g., executing step S12 after step S13 of FIG. 8).

When the situation changes to the second situation, this configuration prevents the history of actions including an action to be restricted from being reflected on the specific user's computer.

(5) The above (1) comprises:
a step of, in the second situation, setting a new action to be restricted that is among actions reflected on the plurality of computers, in response to an operation from the specific user (e.g., the NG setting unit 253 sets a candidate NG word requested by a SP user participating in the virtual space of certain content (including the case where the SP user themselves is distributing the content) as the SP user's NG word without waiting for the operator to set it, and the SP user is allowed to use the input information transmission unit 356 to drag and highlight a part of the message to be used as a candidate NG word from the comment reflected in the comment history in the virtual space of the content in which they are participating, thus applying for it to be set as the NG word).

This reduces the time and effort required to set an action to be restricted and improves convenience for a specific user.

(6) In the above (1), the specific relationship is a relationship associated with a common group (e.g., see FIG. 6A to FIG. 6C).

This configuration makes it possible to restrict the reflection of actions to be restricted among computers operated by the users associated with a common group.

(7) In the above (1), the specific relationship is a relationship in which a character corresponding to a user (e.g., a user character) is placed within a predetermined range in the virtual space (e.g., see (2) in <Modification Examples>).

This configuration makes it possible to restrict the reflection of actions to be restricted among computers operated by the users whose characters are placed in a predetermined range of the virtual space.

(8) In the above (1), the action includes a comment.

The method comprises a step of, even in the first situation, when a comment received from one of the plurality of computers contains a restriction message (e.g., a default NG common to all users) that is predetermined as a message whose reflection is restricted, performing a process of restricting reflection of a part of the restriction message in the comment and of reflecting the comment other than the part of the restriction message on the plurality of computers (e.g., step S22 in FIG. 8), and
in the step of performing a process of restricting the reflection of the action to be restricted, when a comment including a message to be restricted set as the action to be restricted is received in the second situation, a process is performed to restrict the reflection of the comment including the message to be restricted (e.g., if YES in step S17 of FIG. 8, the received comment itself is not reflected).

With this configuration, for a restriction message, the comment other than the restriction message can be reflected, whereas for a message to be restricted, the reflection of a comment itself that includes the message to be restricted can be restricted. This restricts the reflection of a predefined restriction message to a minimum extent, and thus prevents inconveniences such as a failure to carry on a conversation because reflection of a comment that contains a restriction message that the specific user has not specified as a restriction target is restricted.

(9) In the above (1), a user other than a specific user (e.g., general user) also is allowed to set an action whose reflection is to be restricted only among a plurality of users who have a specific relationship that satisfies a special condition (e.g., relevance) on the user, and
only among a plurality of users having a specific relationship that satisfies a special condition on a first user different from a specific user, when an action to be restricted set by the first user is received from any one of the plurality of computers, a process is performed to restrict reflection of the action to be restricted (see, (3) in <Modification Examples>, for example).

This configuration prevents the reflection of the action to be restricted that is set for a user other than a specific user from being overly restricted even when the special condition related to that user is not satisfied.

(10) The above (1) comprises:
a step of receiving candidate information (e.g., NG word setting application) that enables identification of a candidate for a new action to be restricted (e.g., a NG word candidate) in response to an operation from the specific user; and
a step of, when the candidate based on the received candidate information is approved by an operator, setting the candidate as an action to be restricted for the specific user (e.g., setting by the NG setting unit 253).

This configuration allows the action approved by the operator to be set as an action to be restricted, which prevents the use of too many actions to be restricted.

(11) In the above (1), the action to be restricted includes: a first action (e.g., a default NG common to all users) with respect to which the user who performed the action is informed that reflection is restricted when the reflection is restricted, and a second action (e.g., individual NG) with respect to which the user is not informed that reflection is restricted, and
in response to processing of restricting the reflection of the first action by the step of restricting the reflection of the action to be restricted, the method comprises a step of making a notification to the computer operated by the user who performed the first action to notify that the reflection of the first action is restricted (e.g., if YES in step S23 in FIG. 8).

With this configuration, in response to the restriction of reflection of a first action included in the action to be restricted, the user is notified that the reflection is restricted. This suppresses the user to repeatedly perform such a first action.

(12) In the above (1), the plurality of computers, upon receiving an action, reflect the action in a computer that received the action, regardless of whether the action is an action to be restricted, and output action information that identifies the action (e.g., comment posting information) (e.g., see FIG. 9E, for example), and
in the step of restricting the reflection, when the action based on the action information is not an action to be restricted in the second situation, action reflection information is output to reflect the action in the plurality of computers, while when the action is an action to be restricted, the action reflection information (e.g., comment information) is not output (see, for example, FIG. 9F).

This configuration prevents the user who performed the action from being able to know whether the action was actually reflected, and thus prevents the user from specifying the action to be restricted and performing an action in a way that circumvents the restriction.

(13) In the above (1), the specific user is defined to belong to one of a plurality of types,
for the plurality of types, a common action to be restricted is set in advance for each type (see, for example, FIG. 7B), and
in the step of restricting the reflection, when a plurality of specific users are included in the plurality of users having the specific relationship in the second situation, a process may be performed to restrict reflection based not on an action to be restricted set by each of the plurality of specific users but based on a common action to be restricted set in advance for the types to which the plurality of specific users belong (e.g., process to determine whether a plurality of SP users is included in the content between step S16 and step S17 of FIG. 8, and steps S36 and S43 of FIG. 10).

This configuration prevents the number of actions reflected from becoming too small when a plurality of specific users is included in the users who have a specific relationship.

(14) In the above (1), when a specific user is included in the plurality of users having a specific relationship, the action by the specific user may be different from the action that another user different from the specific user is allowed to take (e.g., when a user participates as a distribution user, they are not allowed to post a comment. This allows the SP user to operate the user character of the SP user in the virtual space as if it were the avatar of the SP user.)

This configuration makes the actions that can be taken by a specific user and other users different, allowing each user to take an action appropriate to their situation.

(15) A system that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) for whom an action to be restricted (e.g., a NG word) is configurable.
the system comprising a computer configured to
in a first situation where the specific user is not included in the plurality of users having the specific relationship (e.g., during distribution of a first mode of content, NO in step S15 of FIG. 8), even when the action to be restricted is received from one of the plurality of computers, perform a process of reflecting the action to be restricted on the plurality of computers (e.g., step S20 of FIG. 8), and when a situation changes from the first situation to a second situation where the specific user is included (e.g., during distribution of a first mode of content, YES in step S15 of FIG. 8), and when the action to be restricted is received from one of the plurality of computers, perform a process of restricting reflection of the action to be restricted (e.g., YES in step S17 of FIG. 8).

With this configuration, the action to be restricted is reflected in the first situation, whereas reflection of the action to be restricted is restricted after the situation changes from the first situation to the second situation. This enables appropriate restriction of the reflection of the action to be restricted, depending on whether the specific user is included.

### BRIEF DESCRIPTION OF DRAWINGS

FIG. 1 shows an example of a hardware configuration of a communication system.

FIG. 2 describes the configuration of a distribution server.

FIG. 3 describes the configuration of an administrator terminal.

FIG. 4 describes the configuration of a user terminal (user terminal and distribution user terminal) in detail.

FIG. 5 describes an example of the types of content provided by the distribution server.

FIG. 6A, FIG. 6B, and FIG. 6C describe one example of the log information stored in the storage unit of the distribution server.

FIG. 7A, FIG. 7B, and FIG. 7C describe one example of the NG information stored in the storage unit of the distribution server.

FIG. 8 is a flowchart of the comment control process during distribution of a first mode of content.

FIG. 9A, FIG. 9B, FIG. 9C, FIG. 9D, FIG. 9E and FIG. 9F describe display examples of a user terminal during distribution of a first mode of content.

FIG. 10 is a flowchart of the comment control process during distribution of a second mode of content.

FIG. 11A, FIG. 11B, FIG. 11C, FIG. 11D, FIG. 11E, and FIG. 11F describe display examples of a user terminal during distribution of a second mode of content.

FIG. 12 is a flowchart of the comment control process during distribution of a third mode of content.

FIG. 13A, FIG. 13B, FIG. 13C, FIG. 13D, FIG. 13E, FIG. 13F, FIG. 13G, and FIG. 13H describe display examples of a user terminal during distribution of a third mode of content.

### DETAILED DESCRIPTION

The following describes embodiments of a communication system according to the present invention, with reference to the drawings. The present invention is not limited to the following examples, and is defined by the claims. All modifications within the meaning and scope equivalent to the claims are intended to be included in the present invention. In the following descriptions, like reference numerals designate like parts throughout the descriptions of drawings to omit their duplicated descriptions.

### First Embodiment

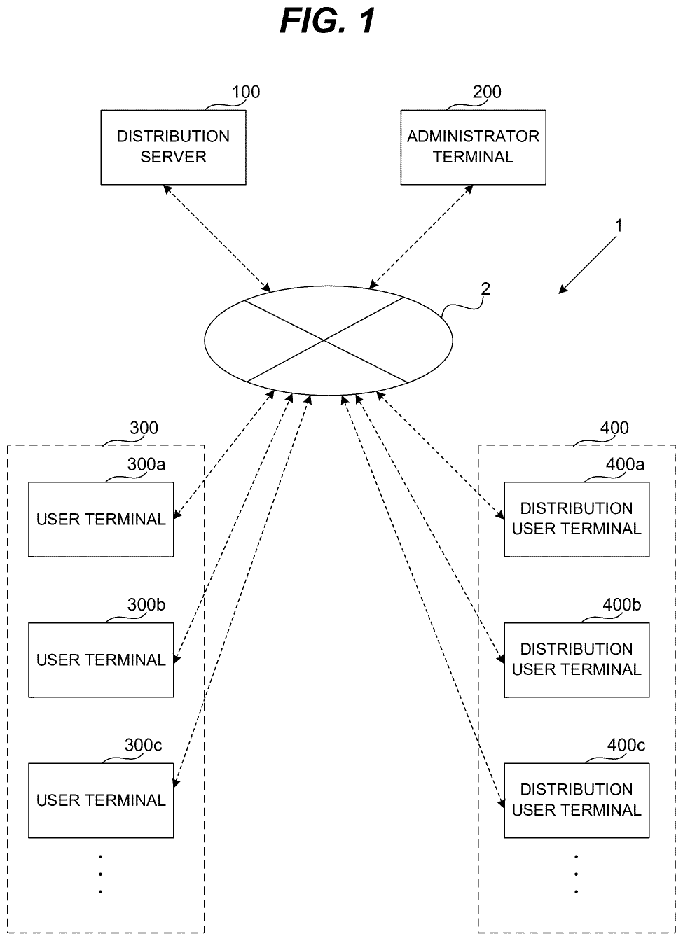

FIG. 1 shows an example of a hardware configuration of a communication system 1. The communication system 1 includes a distribution server 100, an administrator terminal 200, a plurality of user terminals 300a, 300b, 300c . . . , and a plurality of distribution user terminals 400a, 400b, 400c . . . . Each of the plurality of user terminals 300a, 300b, 300c, . . . are owned by one of a plurality of users, and they are hereinafter collectively referred to as a user terminal 300. Each of the plurality of distribution user terminals 400a, 400b, 400c, . . . are owned by one of a plurality of distribution users who are able to distribute content initiatively, and they are hereinafter collectively referred to as a distribution user terminal 400. Both the user terminal 300 and the distribution user terminal 400 are used by a user. Thus they will hereinafter be referred to collectively as user terminals.

The distribution server 100, the administrator terminal 200, the user terminals 300, and the distribution user terminals 400 are connectable for communication via a network 2, and are able to transmit and receive information (data) in both directions. The network 2 is the internet, for example, and includes local area network (LAN), wide area network (WAN), mobile communication network (e.g., 5G and wireless network), wired telephone network, fiber to the home (FTTH), cable television (CATV) network, and other access networks.

For instance, the distribution server 100 is a computer such as a workstation or a personal computer having a communication function. The distribution server 100 manages multiple virtual spaces, which are virtual worlds constructed over a computer, and provides services (content) using the virtual space selected by a user via the network 2.

The users in this embodiment include general consumers, performers and celebrities. For instance, performers include talented people from various genres, such as performers belonging to service providers (operating companies), entertainers, actors, comedians, multi-talented people, emcees, anchorpersons, singers, musicians, and models. For instance, celebrities include famous company executives or employees, athletes, e-sports players, famous scholars and cultured persons, cram school tutors, famous students, and other famous people of various genres.

A virtual space is managed and set up for each type of content offered. The content that can be offered includes, but is not limited to, content that allows users to watch or experience games, live performances, live events, programs, and others, and content that allows users to interact and communicate with each other using chats and emotes. A user accesses the distribution server 100 using the user terminal 300 or the distribution user terminal 400 and selects desired content, thereby seamlessly participating in (navigating) the content and being able to view and experience the virtual space corresponding to the content.

Depending on the type of content, a virtual space may include a three-dimensional space (space constructed on the basis of three-dimensional data) generated by computer graphics (CG) or a two-dimensional space (space constructed on the basis of two-dimensional data). The virtual space also provides a virtual character (avatar object), an object showing backgrounds and virtual objects according to the type of content, a menu object selectable by the user, and others. The virtual character placed in the virtual space includes a user character that is preset corresponding to each user participating in the virtual space and is operable in response to operations from the user, and a non-player character that operates according to a program.

An object to be placed in the virtual space includes: for game content, a character object corresponding to the game, and a user character of a user playing the game content that are placed on a field object corresponding to the game field; and for live event content, a stage object, an audience seat object and a lighting object, a user character of the performer performing as the emcee of the live performance on the stage object, and user characters of participating users that are placed on the audience seat object. For content that lets users communicate with each other, the objects placed include a user character for each of the multiple users participating and an item object that can be used for communication.

The distribution server 100 stores, in its storage unit 120, information for displaying images in a plurality of virtual spaces corresponding to the distributable content on a user terminal, and sound information for outputting sound. In response to an access from a user terminal, the distribution server 100 distributes content data that includes display information for displaying images in the virtual space of the corresponding content and sound information for outputting sound, thus providing the content (service) to the user.

For instance, the content data includes: information for specifying information relating to an object placed within the virtual space (e.g., the type of object, placement position, orientation, posture, and appearance); information relating to the user character of each user participating in the virtual space (e.g., the type of user character, placement position, orientation, posture, appearance, motion data, and audio data); an object indicating backgrounds or virtual objects according to the type of content; and information for specifying menu objects selected by the user.

An object in the virtual space may change in the posture, position, facial expression, and others in response to operations through a user terminal, and the appearance of an object placed may change over time. Therefore, the content data is distributed at predetermined intervals (e.g., every 0.016 seconds, which is about 60 fps), enabling images in the virtual space that change from moment to moment to be displayed on the user terminal.

The administrator terminal 200 is used by an operator of a service provider, for example. For instance, the administrator terminal 200 is a computer with operation input and communication functions, such as a personal computer. The operator creates, configures, modifies, and updates the content and images in the virtual space to be managed in the storage unit 120 of the distribution server 100 via the administrator terminal 200. For instance, the operator creates and configures new content and images in a virtual space, and changes and modifies existing content and images in a virtual space. The operator also sets and updates the information to be managed in the storage unit 120 of the distribution server 100 via the administrator terminal 200.

In this embodiment, the distribution server 100 and the administrator terminal 200 are each independent computer (apparatus). In another embodiment, they may be implemented by one computer, or the functions of one of these computers (e.g. the distribution server 100) may be implemented by multiple computers (e.g., multiple servers).

The user terminal 300 is used by a user who views and experiences content. For instance, the user terminal 300 may be a computer with operation input and communication functions, such as a personal computer, a tablet terminal, and a smartphone. Like the distribution user terminal 400 described later, the user terminal 300 may have a motion capture function to capture user actions.

The user terminal 300 communicates with the distribution server 100 in response to an operation with the terminal to receive content data of the content selected by the user. The user terminal 300 configures, in the storage area of the user terminal 300, a virtual space for the content selected by the user from among the virtual spaces configured in the distribution server 100 on the basis of the received content data, and displays images in the virtual space and outputs sound. This allows the user to view and experience the virtual space of the content via the user terminal 300.

The user terminal 300 also accepts operations on the displayed virtual space and objects. The user terminal 300 transmits information in accordance with the operation with the terminal to the distribution server 100 to operate and move their user character within the virtual space of the content in which the user is participating. The movement of the user character, for example, may be reflected (synchronized) also in the virtual space at each of the user terminals 300 of users participating in the same content, on the basis of the content data transmitted from the distribution server 100 at predetermined time intervals as described above.

While the user terminal 300 enables the user to view and experience the virtual space of content, it also allows the user to post a comment including any message that is an example of action for the virtual space of content where the user is participating in response to an operation with the user terminal. After posting of the comment, such a comment may be reflected on each user terminal 300 so that the users participating in the content are allowed to check such a comment.

The distribution user terminal 400 is used by a distribution user who is able to distribute content. In addition to the operation input and communication functions, the distribution user terminal 400 has a motion capture function to capture the actions of a distribution user (e.g., a head-mounted device (HMD), a device equipped with an image capturing device to analyze user actions from images of the user taken by the image capturing device). In this case, the user wears the HMD on the head, for example, and holds a controller that is communicable with the HMD with a hand. Then, when the user moves the head or hand or operates buttons of the controller, this enables the operation of the displayed virtual space and virtual characters.

The distribution user terminal 400 may acquire motion information to identify the head or hand movements of the distribution user and controller operations, and audio information to identify the voice of the distribution user, and transmit it to the distribution server 100 to reflect the user character's movements and voice in the participating virtual space. This allows the distribution user terminal to operate the user character of the distribution user in the virtual space as if it were the avatar of the user. The movement and voice of the user character, for example, may be reflected (synchronized) in the virtual space at each of the user terminals of users (including the distribution user) participating in the virtual space, on the basis of the content data transmitted from the distribution server 100 at predetermined time intervals as described above.

Note that the distribution user may be a general user (just a viewer or participant) who views or experiences the distributed content using the user terminal 300 with the same configuration as the distribution user terminal 400, or may be a general user using the user terminal 300 with a configuration different from the distribution user terminal 400. The distribution user terminal 400 and the user terminal 300 may be terminals having the same configuration or may be terminals having different configurations. A distribution user may participate in a virtual space as a distributor who distributes content, or as a general user (just a viewer/participant), not as a distributor. Therefore, a distribution user is included in users. A distribution user is allowed to select or change which position they are in, for example, at a specific timing (e.g., when logging in, when starting content distribution, when displaying the user character of the distribution user in the content to be distributed).

### <Configuration of Distribution Server>

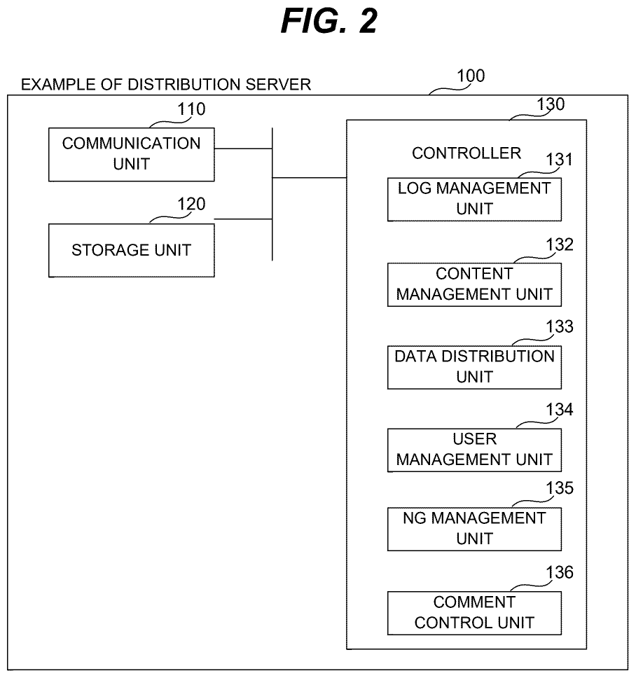

Next the following describes the configuration of the distribution server 100. As shown in FIG. 2, the distribution server 100 includes a communication unit 110 that communicates with other computers, a storage unit 120 that stores various data, and a controller 130 that controls the entire computer. These communication unit 110, storage unit 120, and controller 130 are connected to each other by a bus line.

The communication unit 110 is a communication interface including a network interface card controller (NIC) for performing wired or wireless communication. The communication unit 110 communicates with other computers via the network 2.

The storage unit 120 includes a random access memory (RAM), a read only memory (ROM), a flash memory or a hard disk drive (HDD). The storage unit 120 stores programs for executing various control processes (e.g., programs for managing and providing content using a virtual space), various data, and others. The various data stored in the storage unit 120 includes information for specifying an image of a virtual space provided for each type of content, user information relating to a user, NG information (in this description, the term NG represents No Good that is taboo or inappropriate) relating to a NG word, and log information relating to an access from a user.

The controller 130 includes a central processing unit (CPU). The controller 130 executes a program stored in the storage unit 120 to control the overall operation of the distribution server 100.

The following describes a functional configuration of the controller 130. The controller 130 functions as at least a log management unit 131, a content management unit 132, a data distribution unit 133, a user management unit 134, a NG management unit 135, and a comment control unit 136.

In response to access from a user terminal, the log management unit 131 stores log information in the storage unit 120, and the log information includes: participating user information for identifying users participating in each content/virtual space; related user information for identifying related users who are associated with the content, such as those who initiatively distribute the content; and action information (comment history, described below) for specifying the action history of users in the virtual space (e.g., the content of posted comments and the history of users who posted the comments).

The content management unit 132 stores and updates, via the communication unit 110, information for specifying an image in a virtual space corresponding to the content set by the administrator terminal 200 in the storage unit 120. The content management unit 132 stores in the storage unit 120: information for specifying the type of content set by the administrator terminal 200; information for specifying an image in the virtual space for each piece of content; and information for specifying the date and time of distribution for content (program) to be distributed at a predetermined date and time, for example. The information for specifying an image in the virtual space includes information on objects placed in the virtual space, user characters corresponding to users participating in the virtual space, and others.

The data distribution unit 133 distributes content data to the user terminal, from which the access originated, at predetermined time intervals. The content data is for displaying images in the virtual space of the content selected with each terminal and managed by the content management unit 132.

The user management unit 134 stores and updates user information relating to users in the storage unit 120. The user information relating to a user includes an ID for identifying the user, the user name, and others.

The NG management unit 135 stores and updates NG information relating to NG words in the storage unit 120. NG words are words (messages) that have been designated so that their reflection in chats within virtual spaces can be restricted or controlled. The NG information regarding NG words includes, for example, information for specifying NG words set for each user and default NG words that are defined in advance.

The comment control unit 136 receives a comment posted by each user and transmits comment information for identifying the comment to a user terminal of a user participating in the same content as the user who posted the comment, thereby reflecting the comment in the virtual space of the content. Further, the comment control unit 136 determines whether a posted comment contains a NG word, and if the comment contains a NG word whose the reflection should be restricted, the comment control unit 136 restricts the transmission of the comment information so that at least the NG word contained in the comment is not reflected in the virtual space. In this embodiment, a posted message (comment) is shown as an example of an action in the virtual space and an action to be restricted. The action is not limited to a posted message (comment) as described later.

### <Configuration of Administrator Terminal>

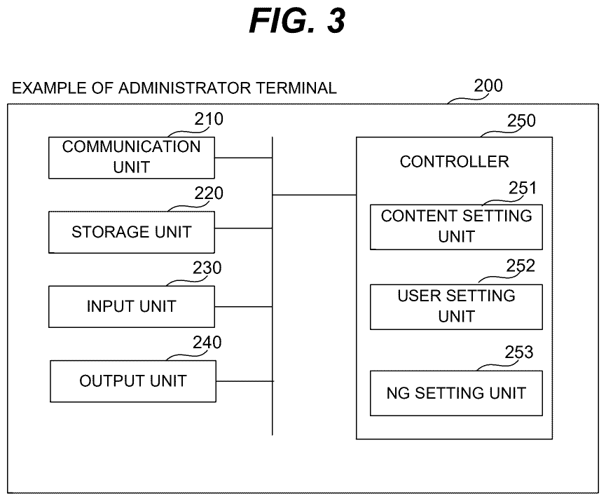

Next the following describes the configuration of the administrator terminal 200. As shown in FIG. 3, the administrator terminal 200 includes a communication unit 210 that communicates with other computers, a storage unit 220 that stores various data, an input unit 230 for inputting operations, an output unit 240 for outputting images and audio, and a controller 250 that controls the entire computer. These communication unit 210, storage unit 220, input unit 230, output unit 240, and controller 250 are connected to each other by a bus line.

The communication unit 210 is a communication interface including a NIC for performing wired or wireless communication. The communication unit 210 mainly communicates with the distribution server 100 via the network 2. The storage unit 220 includes a RAM and a ROM. The storage unit 220 stores programs for executing various control processes (e.g., programs for managing content using a virtual space), various data, and others.

The input unit 230 includes an input device (e.g., a pointing device such as a touch panel, a touch pad, or a mouse, and a keyboard) for receiving input operations from the administrator. The output unit 240 includes an output device (e.g., display, speaker) for presenting information to the administrator.

The controller 250 includes a CPU. The controller 250 executes programs stored in the storage unit 220 to control the overall operation of the administrator terminal 200.

The following describes a functional configuration of the controller 250. The controller 250 functions as at least a content setting unit 251, a user setting unit 252, and a NG setting unit 253.

The content setting unit 251 stores and updates information about the content and virtual space that is managed by the content management unit 132 of the distribution server 100 in response to operations with the administrator terminal 200. This allows information for specifying content, information for specifying an image within the virtual space for each piece of content, information for specifying the date and time of the distribution, and information for setting and specifying a user (related SP user described later) who has the relevance with the content to be stored and updated in the storage unit 120.

The user setting unit 252 sets user information about a user that is managed by the user management unit 134 of the distribution server 100 in response to an operation with the administrator terminal 200. The user information settings include a distribution user setting that sets the user as a distribution user who is able to distribute content in response to a request from the user, and a SP user setting that sets the user as a special user (hereinafter also referred to as a SP user) who is able to set a NG word in response to a request from the user. For instance, when an application is received from a user who belongs to a performer or a celebrity and when the user satisfies certain standards (requirements), the operator sets the user as a distribution user or SP user. SP users are set up from among performers and celebrities. The operator may set a particular user as a distribution user or SP user even if no application is made.

In addition to the settings for SP user, the SP user settings include a type that is classified based on various parameters such as the user's genre, group, age group, and gender (e.g., a type of idol group A, a type of young actors, a type of big-name comedians, a type of professional baseball player, and a type of professional shogi players, hereinafter they may be called SP1, SP2, SP3 . . . ). A user who is set as a distribution user is able to initiatively distribute content, and is also necessarily set as a SP user who is able to set NG words. Therefore, in the distribution user settings, the type is also set when setting the distribution user as in the SP user. In the following, the SP user includes a distribution user. User information related to a user is set, whereby information for identifying the type of user (e.g., general user, distribution user, and SP user) is stored and updated in the storage unit 120 so as to correspond to a user ID for identifying the user. That is an example in which the distribution user settings and the SP user settings (including the type settings) are made in response to the operation with the administrator terminal 200 by the operator. The present invention is not limited to this, and instead of or in addition to this, the settings may be made in response to an operation with the user terminal by the user themselves. In this case, the operator may send, via the administrator terminal 200, to a user who belongs to performers and celebrities and is to be the target of distribution user settings or SP user settings, a setting form screen for distribution user settings or SP user settings or a URL that can be connected to the screen, so that the setting can be made according to the operation by the user who is the target of settings. This avoids the possibility of distribution user settings and SP user settings being made by general users.

The NG setting unit 253 sets NG information about a NG word that is managed by the NG management unit 135 of the distribution server 100 in response to an operation with the administrator terminal 200. The settings of NG information about NG words include: individual NG settings such as setting of NG word candidates requested in response to application from a SP user (including a distribution user) as the NG words of the user who made the request, or removing words requested by a user to be removed from the NG word list; and default NG settings such as setting/removing of default NGs for each type of SP user or default NGs common to all users.

For instance, when the candidate NG word requested from a SP user meets certain criteria (requirements) such as low risk of leading to excessive restrictions, the operator sets this candidate NG word as the NG word for the user. Note that a candidate NG word requested from a SP user may be set as a NG word of the SP user without waiting for the setting from the operator. For instance, a NG word candidate may be proposed from a SP user who is participating in the virtual space of certain content (including the case where the user themselves is distributing the content). In this case, the candidate may be set as a NG word for such a SP user without waiting for the setting from the operator. Then, in this case, the candidate may be set as a NG word only in the content in which the user is participating, and after the distribution of such content is completed, it may be removed from the NG word list and set as a NG word candidate, waiting to be set by the operator. This allows the candidate to be instantly set as a NG word in response to a request from the SP user only in the content in which the SP user is participating, and subsequently restricts the word from being reflected in the content in which the SP user is participating.

In addition, the operator sets words that are determined to be restricted based on, for example, the trends and fashions of the time, as default NG words. NG information related to NG words is set, whereby information for specifying a NG word so as to correspond to a user ID for identifying a user, and information for specifying NG words that are determined in advance for all users or NG words that are determined in advance for each type of SP users are stored and updated in the storage unit 120.

### <Configuration of User Terminal>

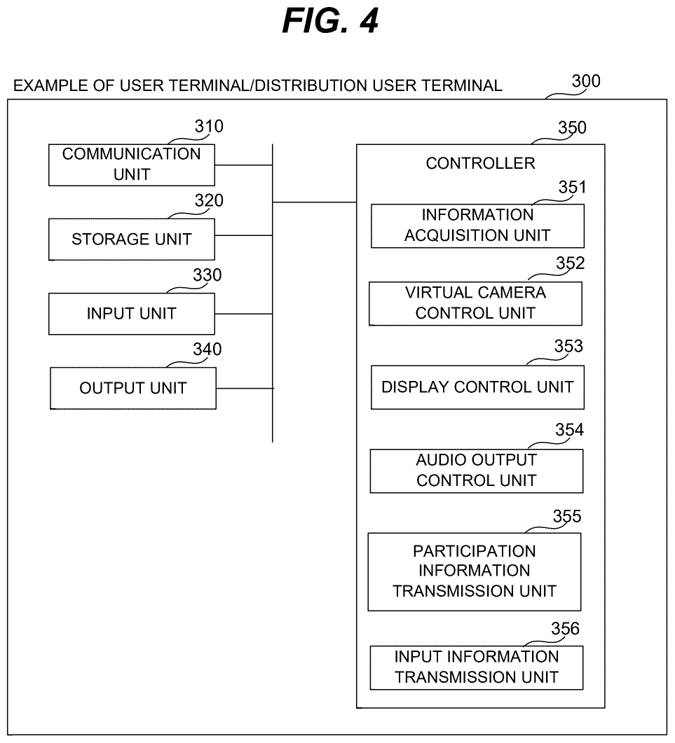

Next, the following describes the configuration of a user terminal (user terminal 300 and distribution user terminal 400) in detail. As shown in FIG. 4, a user terminal includes a communication unit 310 that communicates with other computers including the distribution server 100, a storage unit 320 that stores various data, an input unit 330 for inputting operations, an output unit 340 for outputting images and others, and a controller 350 that controls the entire computer. These communication unit 310, storage unit 320, input unit 330, output unit 340, and controller 350 are connected to each other by a bus line.

The communication unit 310 is a communication interface including a NIC for performing wired or wireless communication. The communication unit 310 communicates with other computers including the distribution server 100 via the network 2. The storage unit 320 includes a RAM and a ROM. The storage unit 320 stores programs for executing various control processes (e.g., programs for viewing content using a virtual space, and programs for distributing content using a virtual space in a distribution user terminal via the distribution server 100), various data, and others.

The input unit 330 includes an input device (e.g., a pointing device such as a touch panel, a touch pad, or a mouse, a keyboard, and microphone) for receiving input operations and sounds from a user. The distribution user terminal 400 includes an input device such as an HMD with a motion capture function and includes a motion input unit that is an input unit 330 to acquire user motions as motion information. In this way, the distribution user terminal 400 used by a distribution user for content distribution has hardware and functions different from those of the user terminal 300 used for participation as a general user.

The output unit 340 includes an output device (e.g., display, or speaker) for presenting and outputting information (text, images, sounds and others) to a user. The controller 350 includes a CPU. The controller 350 executes programs stored in the storage unit 320 to control the overall operation of the user terminal 300.

The following describes a functional configuration of the controller 350. The controller 350 functions as an information acquisition unit 351, a virtual camera control unit 352, a display control unit 353, an audio output control unit 354, a participation information transmission unit 355, and an input information transmission unit 356.

The information acquisition unit 351 acquires content data, comment information, and others from the distribution server 100 via the communication unit 310, and stores in the storage unit 320 information for displaying an image in a virtual space in which various objects are placed based on the content data, and also stores in the storage unit 320 information for displaying comments posted based on the comment information.

The virtual camera control unit 352 controls a virtual camera that is placed in the virtual space stored in the storage unit 320 and specifies a region (visible region) of an image in the virtual space to be displayed on the user terminal 300. The virtual camera control unit 352 controls the position, orientation, inclination, and others of the virtual camera in response to an operation with the input unit 330.

The display control unit 353 displays on a display unit (such as a display) an image corresponding to the visible region, which is the field of view from the virtual camera, in the virtual space stored in the storage unit 320, on the basis of the content data acquired by the information acquisition unit 351. In other words, the user can change the position, orientation, inclination and others of the virtual camera placed in the virtual space in response to operations with the input unit 330, so that the user terminal 300 displays an image within the visible region of the virtual camera among the image in the virtual space for viewing.

This embodiment describes an example where information for displaying an image in a virtual space based on content data is stored in the storage unit 320, a virtual camera is placed in the virtual space stored in this storage unit 320, and the visible region displayed on the user terminal 300 is changed by controlling the virtual camera. The present invention is not limited to this. For instance, the user's virtual camera may be placed in the virtual space stored in the storage unit 120 of the distribution server 100, and the virtual camera control unit 352 may be used to control the virtual camera to change the visible region of the virtual camera. Then data to specify an image in the visible region may be received and displayed on the user terminal 300.

The display control unit 353 causes the display unit (e.g., a display) to display the history of posted comments stored in the storage unit 320 based on the comment information acquired by the information acquisition unit 351. The audio output control unit 354 causes an audio output unit (e.g., speaker) to output sounds on the basis of the content data acquired by the information acquisition unit 351.

The display control unit 353 displays user interface (UI) images (including a menu image selectable by the user and an operation image that accept operations) corresponding to the content being distributed on the basis of the program stored in the storage unit 320. In this embodiment, different UI images are displayed on a user terminal 300, which is used for participation as a general user, and on a distribution user terminal 400, which is used by a distribution user for content distribution. For instance, a UI image for posting a comment may be displayed on the user terminal 300 (when the program is executed for viewing/experience), but not displayed on the distribution user terminal 400 (when the program is executed for content distribution), which mainly communicates by sounds. The menu items required are different also between during viewing/experiencing and during content distribution. Thus, the UI image for selecting a menu may differ between the user terminal 300 (when executing a program for viewing/experiencing) and the distribution user terminal 400 (when executing a program for content distribution).

The participation information transmission unit 355 transmits participation information to the distribution server 100 when a user indicates a desire to participate on a screen showing a list of information on the content being distributed. The participation information indicates that the user will participate in the content that the user has input (selected) via the input unit 330. The participation information includes information for specifying the content to be participated in and the user ID of the user.

The input information transmission unit 356 transmits the audio information, operation input information, and others acquired by the input unit 330 to the distribution server 100. The operation input information includes various types of information, such as operation information for specifying operations on objects in the displayed virtual space and on the user characters placed in the virtual space (including motion information acquired by the motion input unit 260 (such as an HMD)), comment posting information for specifying a comment input by a user when the user posts a comment in the participating content, and user application information for specifying setting and cancelling applications by distribution users and SP users, and setting and cancelling applications for NG words.

To apply for a NG word setting, instead of or in addition to inputting a message about a candidate NG word, the SP user themselves may drag and highlight a part of the message to be used as a candidate NG word from the comment reflected in the comment history in the virtual space of the content in which they are participating. This reduces the time and effort required to apply for NG word candidates.

In this embodiment, regardless of whether or not a comment input by a user to post the comment contains a NG word, the comment is reflected in the virtual space of the content displayed on the user terminal of the user at the time of input (posting). If the reflection of a posted comment is restricted because it contains a NG word, the reflection will be restricted in the virtual space of content that is displayed on the user terminals of users other than the user who posted the comment.

### <Types of Content>

Next, the following describes an example of the types of content provided by the distribution server 100. For instance, the types of content provided can be broadly divided into: content for communication with other participating users that is not related to any of the SP users (including distribution users) who are set as performers and celebrities; and content that is related to any of the SP users. For instance, examples of the content that is not related to any of the SP users include content that is not distributed initiatively by any of the SP users, in which the participation of any of the SP users has been decided in advance, and content that is not based on the intention of communication with any of the SP users (e.g., a gathering of fans of a particular performer who is a SP user). In contrast, examples of the content that is related to any of the SP users include content that is distributed initiatively by any of the SP users, content in which the participation of a SP user at any timing has been decided in advance before the start of the content, and content that is based on the intention of communication focusing on any of the SP users (e.g., content where fans of a particular performer who is a SP user will be gathered).

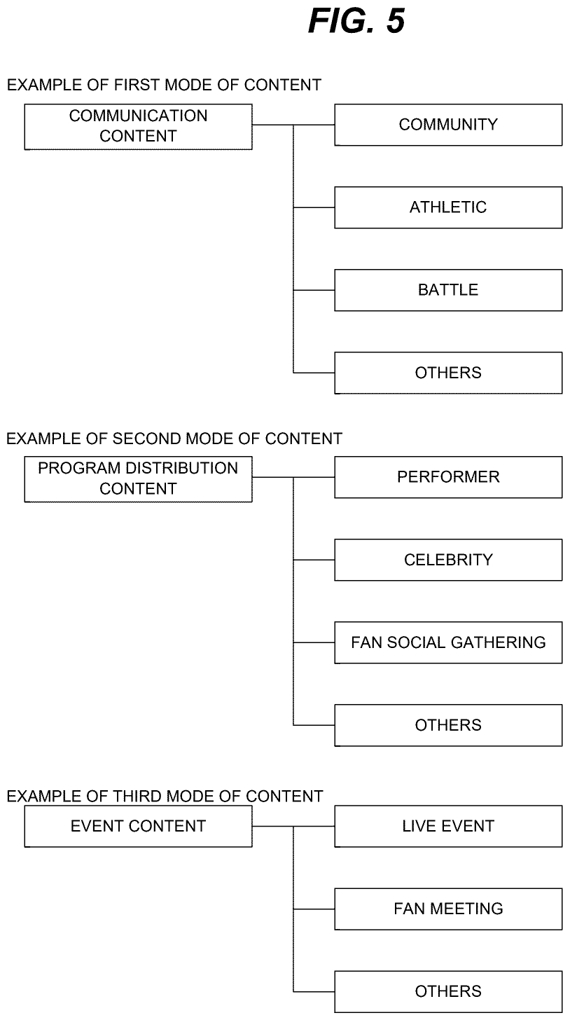

As shown in FIG. 5, communication content is provided, which is not related to any SP user and is for communicating with other participating users. For example, this includes community content for exchanging information about a particular region, athletic content in which a user controls a user character to play an athletic game together with other users, and battle content in which a user controls a user character to battle with other users. Hereinafter, the content that is not related to any SP user and that is for communication with other participating users is also called a first mode of content.

For the first mode of content, a user is able to participate in the desired content at any time, and a SP user, such as a performer or celebrity, also is able to participate in the desired content at any time. Thus, the first mode of content can be content in which a SP user may or may not participate, and in which topics may or may not be about any of the SP users, and it can be content that is not related to SP users.

In contrast, content that is related to any of the SP users includes program distribution content that is distributed on a regular basis and event content that is distributed as a live event. Program distribution content includes: talent content in which a specific talent set as a SP user appears and distributes content initiatively; celebrity content in which a specific celebrity set as a SP user appears and distributes content initiatively; and fan social gathering content in which a specific performer or celebrity set as a SP user do not appear but their fans gather and communicate with each other. Hereinafter, of the content that is related to any SP user, the program distribution content that is distributed on a regular basis is also called as a second mode of content.

Event content includes: live content in which a live event by a specific talent (e.g., a specific singer, a specific idle group) set as a SP user is distributed, and a fan meeting (this may be called a fan service) content in which a specific performer and others communicate with their fans.

Event content is expected to attract a relatively larger number of users than in program distribution content. This means that comments for the event content will be posted more frequently by many users, and the period during which each comment is displayed will become shorter, making them harder to understand. In addition, in the case of live event content, it will become more likely that the SP user will not be able to recognize the comments and will have difficulty reacting to them. For this reason, when distributing live event content, multiple rooms (corresponding to multiple virtual spaces) are prepared for the content, and participating users are assigned to one of the multiple rooms to enter, so that only comments from users in the room they are in are displayed on the user terminal of the participating users, and comments from users entering other rooms are not displayed.

A SP user who distributes the live event is able to select the room that they will enter from the multiple rooms, and view an image of the selected room (within the virtual space) displayed on the SP user's user terminal, while checking comments from the users in the room. This allows comments posted by many users participating in the live event content to be distributed over the multiple rooms, thus preventing the period during which each comment is displayed from becoming too short and making it easier for the SP user who is the main character in the live event to recognize the comments and preventing the SP user from having difficulty in reacting to the comments. Meanwhile, depending on the type of content, the motion and sound of a user character of a specific performer related to the live event content may be reflected only in the room selected by the specific performer (i.e., only users who enter the room selected by the specific performer is able to view them), or may be mirrored in the multiple rooms corresponding to the content (i.e., all users who enter the multiple rooms are able to view the content regardless of the room selected by the specific performer). Hereinafter, of the content that is related to any SP user, content that is distributed as in a live event is also called as a third mode of content.

For both the second and third modes of content, users who wish to participate becomes able to participate (enter) or the user character of the SP user who becomes the main character is displayed at a predetermined date and time, and then the event will start. For the second third modes of content, the user character of the SP user is displayed in the virtual space at the timing determined by the operator or the timing for the SP user who distributes the content initiatively, with the exception of the content of fan social gathering. Of the second mode of content, fan social gathering content is for fans of a specific SP user to gather, and the specific SP user does not participate. This means that the second and third modes of content can be the content in which a specific SP user always participates or the topics about a specific SP user always come up, and thus can be the content related to any SP user. However, even during a period in which general users are participating in the content, there may be a period during which the user character of the SP user who becomes the main character or the subject of the content does not substantially appear (is not displayed) in the virtual space.

As described above, the first through third modes of content are managed in the content management unit 132 of the distribution server 100 in response to operations with the administrator terminal 200. A user terminal is capable of participating in the content by accessing the distribution server 100 and selecting any of multiple types of content on the screen for selecting the content that the user wishes to view from among the multiple types of content. The distribution server 100 causes the log management unit 131 to store and update log information for each type of content in the storage unit 120.

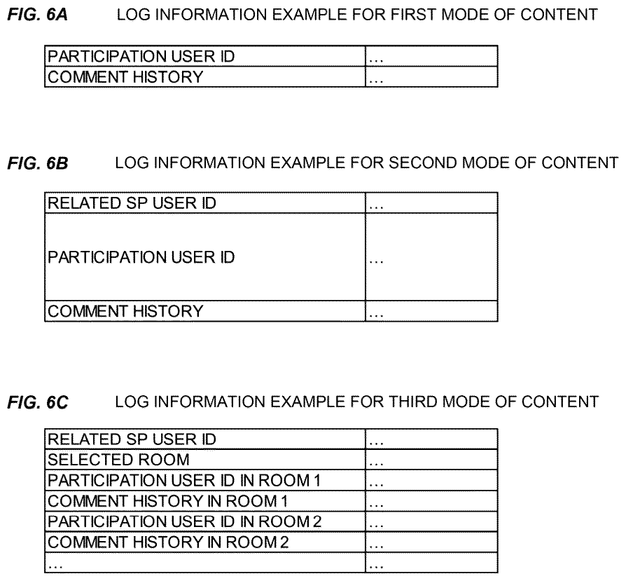

FIG. 6A to FIG. 6C describe one example of the log information stored in the storage unit 120 of the distribution server 100. FIG. 6A shows items of log information that are stored when a user participates in any of the first modes of content. For the first mode of content, the user IDs of the participating users who are participating in the content, and a comment history for specifying comments posted to the content and the users who posted the comments are stored for each piece of content. As shown in FIG. 6A, participating users (users participating in a content group) who participate in common content among the first modes of content and are associated with that content (group) can be users who have a specific relationship.

FIG. 6B shows items of log information that are stored when a user participates in any of the second modes of content. For the second mode of content, the user ID of a specific SP user being related to the content (e.g., a distribution user who initiatively distributes the content, or a performer who has gathered fans; hereinafter, also referred to as a related SP user), the user IDs of participating users who are participating in the content, and a comment history for specifying comments posted to the content and the user who posted the comments are stored for each piece of content. As shown in FIG. 6B, the related SP user and participating users who participate in common content among the second modes of content and are associated with that content (group) can be users who have a specific relationship.

FIG. 6C shows items of log information that are stored when a user participates in any of the third modes of content. For the third mode of content, a related SP user who is related to the content is defined for each piece of content. For the third mode of content, a plurality of virtual spaces are associated with one piece of content. For the third mode of content, a plurality of rooms each corresponding to one of a plurality of virtual spaces is provided, and a user participating in the content is assigned to one of the rooms. The related SP user (e.g., distribution user who distributes a lie event, and a performer who has gathered fans) who are related to the content is able to select a room to enter and check the images and comments in that room. Thus, for the third mode of content, the user ID of the related SP user who is related to the content, the selected room selected by the related SP user from among the multiple rooms, the user ID of a participating user assigned to room 1 of the multiple rooms and the comment history posted to room 1, and the user ID of a participating user assigned to room 2 of the multiple rooms and the comment history posted to room 2 are stored for each piece of content. In this way, the user IDs of participating users and the comment history are stored for each of the rooms. As shown in FIG. 6C, the related SP user and participating users who participate in common content among the third modes of content and are associated with that content (e.g., group, multiple rooms) can be users who have a specific relationship.

During the distribution of a first mode of content, a special condition for a SP user is not satisfied because the special condition is satisfied during the period when the SP user is initiatively distributing the content or the period when the SP user is gathering fans. In contrast, during the distribution of a second mode of content and a third mode of content, such a special condition for the SP user is satisfied.

Participating in any of the content, a user is able to view images and others in a virtual space corresponding to the content, while posting and checking comments, which are one type of action. Note that, if any NG word, which should be restricted, is included, this embodiment restricts the NG word so that it is not reflected in the virtual space of the content. As described above, the SP user is able to apply for a NG word candidate by operating the user terminal. Then, the operator is able to check what the user has applied for by connecting to the distribution server 100 via the administrator terminal 200, and is able to set and update the NG information regarding NG words managed by the NG management unit 135 of the distribution server 100 using the NG setting unit 253 in response to operations with the administrator terminal 200.

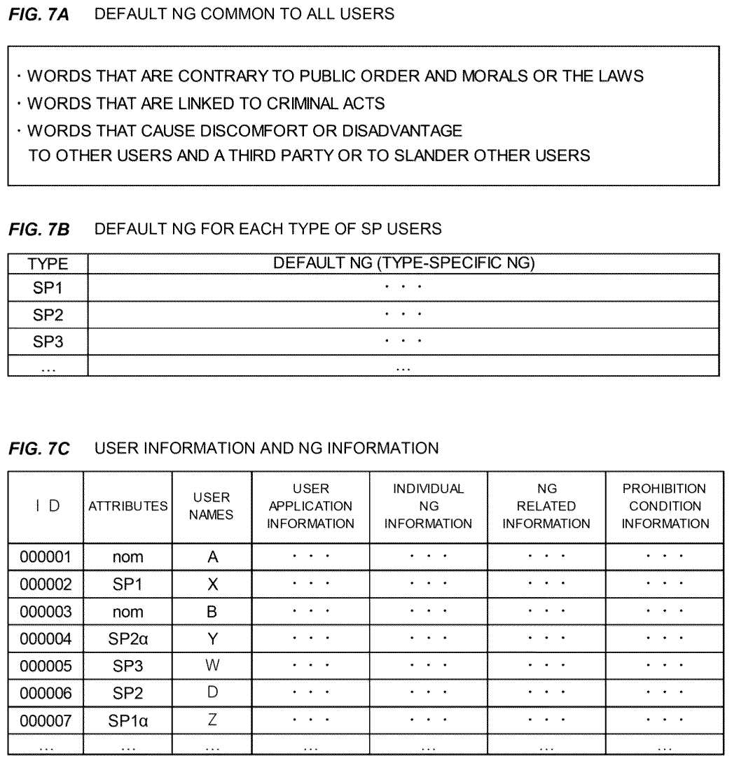

FIG. 7A to FIG. 7C show one example of the NG information stored in the storage unit 120 of the distribution server 100. The NG information stored in the storage unit 120 includes information for specifying default NG words commonly applied to all users. As shown in FIG. 7A, default NG words that are applied to all users are set by the operator, and include words that are contrary to public order and morals or the law, words that are linked to criminal acts, and words that have the potential to cause discomfort or disadvantage to other users or to slander other users.

The NG information stored in the storage unit 120 also includes information for specifying default NG words applied to each type of SP users. The words that SP users wish to set as NG words tend to vary depending on the SP user's genre, group, age range, and others. But if they are of the same type, the same words tend to be included and application for the same words tend to be made by SP users of the same type. For this reason, the operator takes into account the type of a SP user and sets the default NG words to be applied for each type in advance. This reduces the time and effort required for each SP user to set up their own NG words from the very beginning. Note that the default NG words set for each type differ depending on the type, and therefore different NG words can be used for each type. As shown in FIG. 7B, NG information to specify default NG words are stored for each type of SP users.

The NG information stored in the storage unit 120 also includes NG information stored for each user. FIG. 7C shows the NG information stored for each user. The NG information for each user is stored corresponding to user information including, for example, the user ID and user name. The user name and the type of the user (e.g., general user: nom, SP user: SP1, SP2, . . . , distribution user: SP1α, SP2α, . . . ) are stored corresponding to a user ID, and user application information, individual NG information, NG-related information, and prohibition condition information are stored as the NG information.

The application information is for specifying what the user has applied for. The application information includes information indicating a user's desire to set up or cancel the distribution user settings and SP user settings, and information for specifying NG word candidates applied for registration from a SP user, and NG words applied for cancellation from a SP user. The operator connects to the distribution server 100 via the administrator terminal 200, checks and considers what the user has applied for based on the application information, sets or cancels the distribution users and others, and sets or cancels NG words for each user. When setting or cancellation is made for a distribution user, for example, the type shown in FIG. 7C is updated. When setting or cancellation is made for a NG word for each user, the individual NG information shown in FIG. 7C is updated.

The individual NG information shown in FIG. 7C is for specifying NG words set for each user. For instance, when a user's NG word is set by the operator, information to specify the NG word is additionally stored in the individual NG information for that user, and when a user's NG word is canceled by the operator, information to specify the NG word is deleted from the individual NG information for that user. Note that the NG words set individually differ depending on SP users, and therefore different NG words can be used for each SP user.

The NG-related information shown in FIG. 7C is for specifying the history of NG word when the reflection of a comment was restricted because the comment posted by a user contains a NG word. When the comment controller 136 of the distribution server 100 restricts the reflection of a comment in the virtual space because the comment contains a NG word, the comment controller 136 stores and updates NG-related information for the user who posted the comment, the NG-related information including information that is capable of specifying the NG word (message) contained in the comment and the SP user (the SP user, for whom the restriction is required) who sets the word as the NG word to be restricted (including the case of setting it as a type-specific NG). The NG-related information is updated each time a user posts a NG word and it is restricted.

This embodiment is configured so as to, for a user who satisfies a prohibition condition based on the NG-related information for the user, control to prohibit the user from posting comments thereafter, regardless of whether the comments contain a NG word. For instance, when the number of times that a user posted NG words to a certain SP user reaches a predetermined number (e.g., five times), it is determined that the user satisfies the prohibition condition, and the user is prohibited from posting comments on the content that is related to the SP user.

Furthermore, a user who repeatedly uses a NG word also tends to repeatedly use the NG word also against other SP users of the same type as the SP user who sets the NG word. Thus, the posting of comments from a user who satisfies the prohibition condition based on NG-related information for one SP user is prohibited not only for content to which this SP user is related, but also for content to which the same type of SP user as this SP user is related.

The prohibition condition information shown in FIG. 7C is information for specifying the type of SP user who becomes a target to satisfy the prohibition condition and information for identifying the SP user. When a comment is posted from a user who satisfies the prohibition condition in the content to which a SP user of the type as a prohibition target is related, the comment control unit 136 of the distribution server 100 prohibits the comment from being reflected in the virtual space, regardless of whether the comment contains a NG word.

### <Specific Example of Comment Control in First Mode of Content>

Next, the following describes a specific example of the comment control during distribution of a first mode of content. For the first mode of content, a user who is not related to any of SP users is able to participate in at any time, regardless of whether they are a SP user, a performer or a celebrity. This means that a SP user who has set a NG word participates in as a general user and not as a distributor in the middle of content in which general users are already participating and interacting with each other. It is not possible to predict whether this SP user will participate in the content or at what timing the SP user will participate. In addition, a comment containing the NG word set by the SP user who is trying to participate has already been posted in the virtual space of the content. For this reason, the present embodiment is configured so as to, during distribution of a first mode of content, determine whether or not the users participating in the same content include a SP user, and perform comment control according to the determination result. Furthermore, when a SP user participates in any of the first modes of content, the present embodiment controls to delete a comment including a NG word set by the SP user from the comment history for updating, and reflect comments in the virtual space.

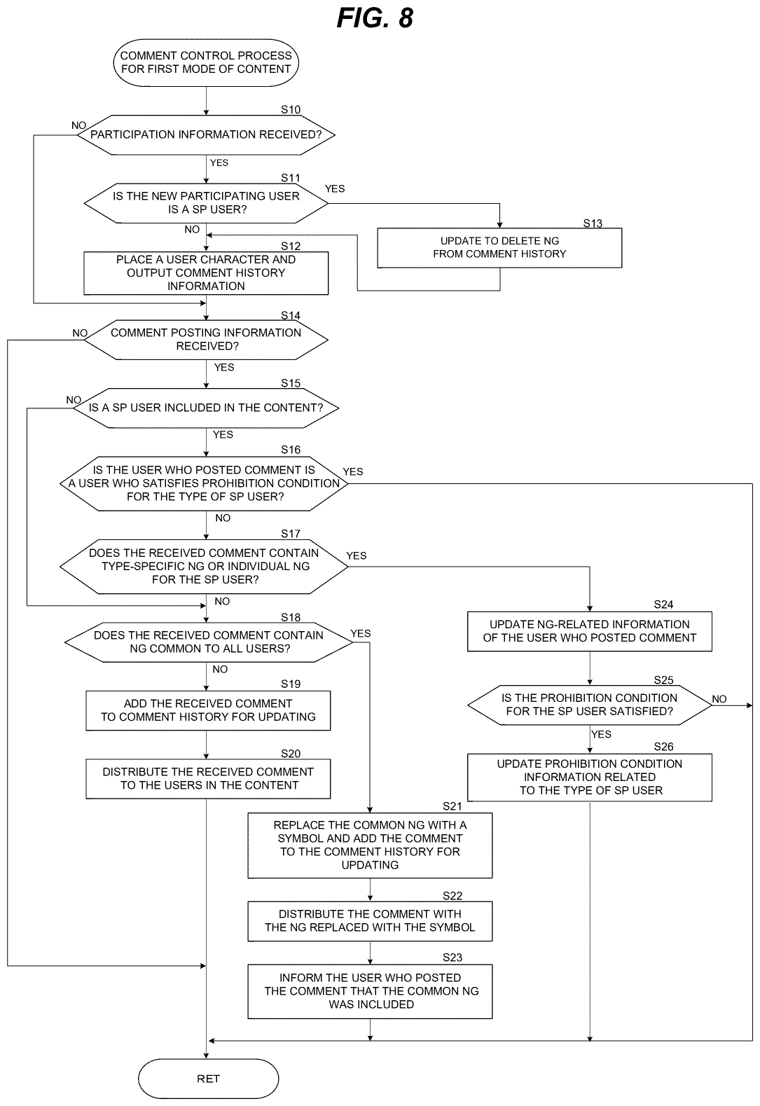

FIG. 8 is a flowchart of the comment control process during distribution of a first mode of content. The comment control process during distribution of a first mode of content is executed for each piece of content, and is repeatedly executed by the controller 130 of the distribution server 100 at predetermined time intervals. The distribution server 100 performs various processes including the comment control process during distribution of a first mode of content on the basis of the program stored in the storage unit 120.

First, in step S10, the process makes a determination as to whether participation information has been received from a user terminal. If it is not determined that the participation information has been received, the process proceeds to step S14. If it is determined that the participation information has been received, the process makes a determination in step S11 as to whether the new participating user is a SP user who is able to set a NG word. In step S11, based on the user information shown in FIG. 7C, the determination is made whether the type of user ID specified from the received participation information is SP rather than nom.

If it is not determined in step S11 that the newly participating user is a SP user, the process proceeds to step S12 to place a user character corresponding to the newly participating user at a predetermined position in the virtual space of the content, and output comment history information for specifying the comment history of the content (see FIG. 6A) to the user terminal of the newly participating user. This allows the content data in which the user character of the newly participating user is placed in the virtual space to be distributed from the distribution server 100, and allows the user character to be reflected and displayed in the virtual space on the user terminal of the user who is participating in the content. Furthermore, the user terminal of the newly participating user receives the comment history information and thereby specifies and displays the comment history posted in the content in which the user has participated.

If it is determined in step S11 that the user is a SP user, the process proceeds to step S13. In this step, if the comment history of the content in which the user participated contains a NG word (e.g., individual NG, type-specific NG) set for the newly participating SP user, the process deletes the comment containing the NG word from the comment history for updating, and proceeds to step S12. Even if the comment history includes a comment including the NG word set for the SP user at the timing when the SP user joins, this allows the comment history information with the comment including the NG word deleted to be output. This therefore prevents a comment containing the NG word from being displayed on the user terminal of the SP user.

If the comment including the NG word set for the newly participating SP user is deleted from the comment history for updating in step S13, the comment history information is output only to the SP user. The present invention is not limited to this. This comment history information may also be output to the user terminals of other users participating in the content in addition to the SP user, so that the comment including the SP user's NG word is not displayed in the comment history on the user terminals of these users. That is a description on the example in which, in step S13, the comment including the NG word set for the newly participating SP user is deleted from the comment history for updating. However, the present invention is not limited to this. The comment including the NG word set for the newly participating SP user may be updated so that the part of the NG word is replaced with a symbol (e.g., asterisk) as described below.

In step S14, the process makes a determination as to whether a comment has been posted to the content from any of the participating users, that is, whether comment posting information has been received. If it is not determined that comment posting information has been received, the comment control process ends. If it is determined that comment posting information has been received, the process makes a determination in step S15 as to whether a SP user is included in the content. Specifically, it is determined whether a SP user ID is included in the participating user IDs shown in FIG. 6A.

If it is not determined in step S15 that the SP user is included, then the process makes a determination in step S18 as to whether the comment (received comment) specified from the comment posting information includes a default NG common to all users shown in FIG. 7A. If it is not determined in step S18 that a default NG common to all users is included, the process adds the received comment to the comment history of the content for updating in step S19. In step S20, the process distributes comment information to specify the received comment to the user terminals of participating users (excluding the user terminal of the user who posted the comment). This allows the posted comment to be reflected in the virtual space. As described above, on the user terminal of the user who posted the comment, the comment is reflected in the virtual space displayed on the user terminal of the user at the time when the comment was input.

If it is determined in step S18 that the default NG common to all users is included, the process proceeds to step S21 to replace the part of the message in the comment corresponding to the default NG with a symbol (e.g., one letter is replaced with asterisk) and add this comment to the comment history of the content for updating. In step S22, the process distributes comment information to specify the received comment with the part of default NG replaced with the symbol to the user terminals of participating users (excluding the user terminal of the user who posted the comment). This allows the posted comment with the part of default NG replaced with the symbol to be reflected in the virtual space. In the first mode of content, a user who becomes the main character/subject of content is not specified. Thus, it is likely to be a conversation (exchange of messages) among the participating users. Then, the default NG part is replaced with a symbol to make the remaining part readable. If the entire comment, including the default NG, is not reflected, a problem may occur, such as a failure to carry on a conversation, thus causing an awkward feeling. This step prevents such a problem. As described above, on the user terminal of the user who posted the comment, the comment including the default NG is reflected in the virtual space displayed on the user terminal of the user at the time when the comment was input.

In step S23, the process transmits notification information to the user terminal of the user who posted the comment to inform that the default NG common to all users was included. This causes a message to be displayed on the user terminal of the user who posted the comment, such as “The comment was partially reflected because it contained a default NG common to all users.” As a result, the user who posted the comment is allowed to know that the comment they posted contained the default NG common to all users.

If it is determined in step S15 that the content includes a SP user, the process makes a determination in step S16 as to whether, based on the NG-related information in FIG. 7C, the user who posted the comment is a user who satisfies the prohibition condition for the type of the SP user (the SP user participating in the same content). If it is determined in step S16 that the user who posted the comment is a user who satisfies the prohibition condition for the type of the SP user, the comment control process ends. This prohibits comments from being posted from the user who satisfies the prohibition condition for the type of SP user participating in the same content.

If it is not determined in step S16 that the user who posted the comment is a user who satisfies the prohibition condition for the type of the SP user, then the process makes a determination in step S17 as to whether the received comment contains the default NG for the type of the SP user shown in FIG. 7B or contains the individual NG for the SP user shown in FIG. 7C.

If it is not determined in step S17 that either the default NG of the type of the SP user or the individual NG of the SP user is included in the received comment, the process proceeds to step S18. Note that if it is not determined in step S15 that a SP user is included, the steps including step S17 will not be executed, and even if the comment contains a NG word that is set for any SP user who is not participating, the comment containing the NG word will be reflected in the virtual space.

If it is determined in step S17 that either the default NG of the type of the SP user or the individual NG of the SP user is included in the received comment, the process updates the NG-related information of the user who posted comment in step S24. This makes it possible to specify the NG word included in the comment and the SP user who sets the word as the NG word to be restricted (including the case of setting the type-specific NG) as NG history from the NG-related information of the user who posted the comment.

Between step S16 and step S17, the process may make a determination as to whether the content contains more than one SP user. In this case, if it is not determined that the content includes a plurality of SP users, the process proceeds to step S17. If it is determined that a plurality of SP users is included, then the process makes a further determination as to whether the received comment contains a type-specific NG for each of these SP users, and if the type-specific NG is not included, the process proceeds to step S18. If the type-specific NG is included, the process may restrict the reflection and proceed to step S24. This prevents too few comments reflected when multiple SP users are included. The present invention is not limited to this. When the types of multiple SP users included in the content are different, it may be determined whether a common type-specific NG is included among the type-specific default NGs of these types, or it may be determined whether one of the type-specific NGs is included among the default NGs of these types.

In step S25, the process makes a determination as to whether the prohibition condition for the SP user is satisfied based on the NG-related information of the user who posted the comment. For instance, it is determined whether the number of times the NG word has been posted to the SP user has reached a predetermined number. If it is not determined in step S25 that the prohibition condition is satisfied, the comment control process ends. If it is determined in step S25 that the prohibition condition is satisfied, the prohibition condition information is updated in step S26 to specify the type of SP user who is a target of the prohibition condition being satisfied. This prevents this user (who posted the comment) from posting a comment within the virtual space of content that is related to a SP user of the same type as that is identified from the prohibition condition information, even if the user has not posted the NG word set by the SP user.

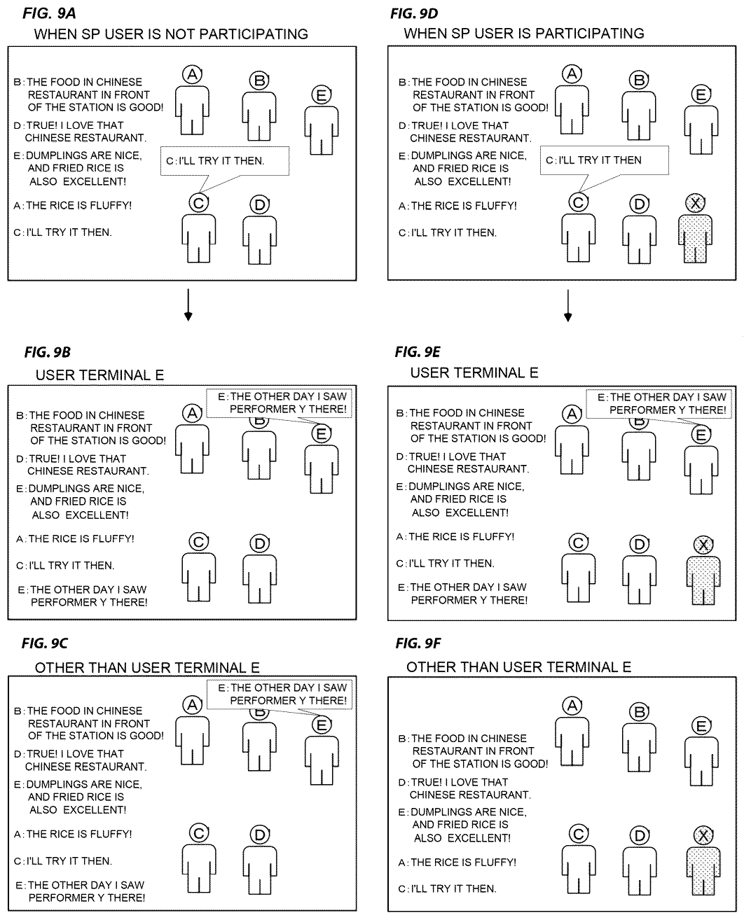

FIG. 9A through FIG. 9F illustrate display examples of a user terminal during distribution of a first mode of content. FIG. 9A through FIG. 9F show display examples of a user terminal of a user participating in community content of the first modes of content. FIG. 9A through FIG. 9C illustrate a situation where a SP user is not included among the users participating in the community content. As shown in FIG. 9A, which shows the user terminal of a user participating in the community content, a field is displayed, in which the user characters of the users participating in the community content move and emote freely from the center to the right area of the screen, and a history of a certain number of comments most recently posted to the community content is displayed in the left area of the screen. In addition to displaying a certain number of most recent comments, the comment history may also be capable of displaying comments posted prior to the certain number of comments by going back in time, in response to an operation.

FIG. 9A shows user characters A to E corresponding to users A to E displayed on the field, comments posted in the order of users B, D, E, and A from the comment history, and a comment such as “I'll try it then!” posted by user C. When a comment is posted, the content of the comment is displayed next to the user name in a word-bubble object from user character C in FIG. 9A, and the content of the comment is also displayed next to the user name in the comment history. This allows the users to be informed of the most recently posted comment in an easily understandable manner.

Following the comment posted from user C, FIG. 9B shows an example of the display on user terminal E of user E when user E posted a comment such as “The other day, I saw performer Y there!”, and FIG. 9C shows an example of the display on a user terminal of a user other than user E who posted the comment. On user terminal E of user E who posted the comment, the posted comment is reflected in the virtual space regardless of whether the comment contains a NG word when posted it, as described above. A user terminal of a user other than the user who posted the comment receives the comment information transmitted in step S20 or S22 of FIG. 8, and has the posted comment reflected in the virtual space.

FIG. 9B and FIG. 9C show a situation where no SP user is included among the participating users, and thus even if a comment is posted that includes a NG word set by one of the SP users, the posted comment is reflected in the virtual space. Therefore, as shown in FIG. 9B and FIG. 9C, the comment from user E is reflected in the virtual space not only on user terminal E but also at a user terminal other than user terminal E.

Note that as mentioned above, the first mode of content allows users, including performers and celebrities, to participate in the content they desire at any time. Therefore, even if no performer or others is participating at the start of distribution, they may join in midway through. FIG. 9D illustrates a situation where the comments posted are the same as in FIG. 9A, but a SP user is included among the users participating in the community content.

FIG. 9D shows, in addition to user characters A to E corresponding to users A to E displayed on the field, user character X corresponding to SP user X who is a SP user, comments posted in the order of users B, D, E, and A from the comment history, and a comment such as “I'll try it then!” posted by user C. As shown in FIG. 9D, the user character of SP user X is displayed, and the user name of SP user X is displayed when they post a comment, for example. This allows other users participating in the content to know that the SP user is participating, and thus increases the likelihood that they will post a comment about the SP user. The user name of a user character may be always displayed near the user character (e.g., above the head) in correspondence with the user character, and in addition, for SP users, a unique icon according to the type may be displayed at the beginning of the line of the user name displayed in correspondence with the user character. It is assumed that the message “I'll try it then!” from user C does not include any of the NG words set by SP user X or the NG words common to the type of SP user X. Thus, the comment from user C is reflected in the virtual space of the content.

Following the comment posted from user C shown in FIG. 9D, FIG. 9E shows an example of the display on user terminal E of user E when user E posted a comment such as “The other day, I saw performer Y there!”, and FIG. 9F shows an example of the display on a user terminal of a user (including SP user X) other than user E who posted the comment. It is assumed that SP user X is an entertainment performer and has set names of some performers as NG words because they do not want the names of other performers who have been rivals to be post, and that “performer Y” is among the NG words.

Also in this case, on user terminal E of user E who posted the comment, the posted comment is reflected in the virtual space regardless of whether the comment contains a NG word when posted it, as described above. This means that, as shown in FIG. 9E, even if the participating users include SP user X and a comment is posted that includes a NG word set by SP user X, the posted comment is directly reflected on user terminal E.

A user terminal of a user other than the user who posted the comment receives the comment information transmitted in step S20 or S22 of FIG. 8, and reflects the posted comment in the virtual space. Note here that the comment posted by user E includes a NG word set by SP user X, and thus the process determines YES in step S17 in FIG. 8, meaning that the comment information is not transmitted in step S20 or S22 in FIG. 8. Thus, in FIG. 9F, which shows a display example on a user terminal other than user terminal E, the comment from user E shown in FIG. 9C is not displayed or reflected in the virtual space of the content at all.

### <Specific Example of Comment Control in Second and Third Modes of Content>

Next, the following describes a specific example of the comment control during distribution of second and third modes of content. The second and third modes of content is related to a specific performer or celebrity, and the specific performer or celebrity will always participate or the topic about the specific performer or celebrity will always come up. However, even during the content distribution period (e.g., the period during which general users are participating in the content), there may be a period during which a related SP user, such as a user character of a particular performer who becomes the main character or subject of the content, does not actually appear (is not displayed) in the virtual space, and there may be a case where they may not appear from the start to finish, as in a fan social gathering. During such a period, a NG word set by the related SP user may be reflected in the virtual space. This may incite participating users to use further NG words, which is not a desirable situation for the related SP user. Thus, during the distribution of the second and third modes of content, this embodiment is configured to perform comment control to restrict the reflection of a NG word set for the relevant SP user who is relevant to the content, regardless of whether the relevant SP user is actually included in the participating users of the content.

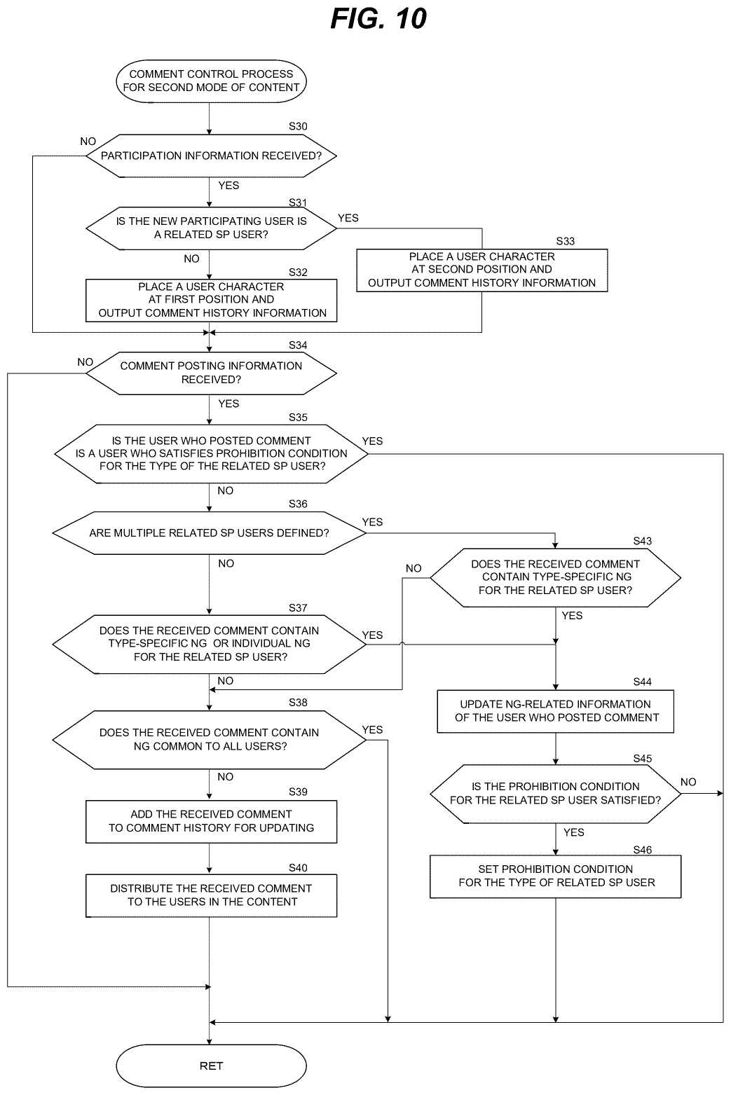

FIG. 10 is a flowchart of the comment control process during distribution of a second mode of content. The comment control process during distribution of a second mode of content is executed for each piece of content, and is repeatedly executed by the controller 130 of the distribution server 100 at predetermined time intervals. The distribution server 100 performs various processes including the comment control process during distribution of a second mode of content on the basis of the program stored in the storage unit 120.

First, in step S30, the process makes a determination as to whether participation information has been received from a user terminal. If it is not determined that the participation information is received, the process proceeds to step S34. If it is determined that the participation information has been received, the process makes a determination in step S31 as to whether the new participating user is a related SP user (e.g., distribution user, or SP user) who is a user who becomes the main character or the subject of the content being distributed and is relevant to the content. In step S31, it is determined whether the user ID is of the related SP user, which is stored for each piece of content shown in FIG. 6B.

If it is not determined in step S31 that the newly participating user is a related SP user, the process proceeds to step S32 to place a user character corresponding to the newly participating user at a first position (e.g., an audience seat) in the virtual space of the content, and output comment history information for specifying the comment history of the content (see FIG. 6B) to the user terminal of the newly participating user. This allows the content data in which the user character of the newly participating user is placed in the virtual space to be distributed, and allows the user character to be reflected and displayed at the first position (e.g., an audience seat, in front of the desk, or outfield) in the virtual space on the user terminal of a user who is participating in the content. Furthermore, the user terminal of the newly participating user receives the comment history information and thereby specifies and displays the comment history posted in the content in which the user has participated. The first position is determined to be a position according to the type of the second mode of content. A user character corresponding to a user who is not a related SP user is displayed in a manner (e.g., size, and color) according to the type of the second mode content, and may not be displayed depending on the type of content.

If it is determined in step S31 that the newly participating user is a related SP user, the process proceeds to step S33 to place a user character corresponding to the participating related SP user at a second position (e.g., on the stage, and on the platform) in the virtual space of the content, and output comment history information for specifying the comment history of the content (see FIG. 6B) to the user terminal of the newly participating user. Then, the process proceeds to step S34. This allows the content data in which the user character of the newly participating related SP user is placed in the virtual space to be distributed, and allows the user character of the related SP user, who becomes the main character or the subject, to be reflected and displayed at the second position in the virtual space on the user terminal of a user who is participating in the content. Furthermore, the user terminal (distribution user terminal 400 in this case) of the newly participating related SP user receives the comment history information and thereby specifies and displays the comment history posted in the content in which the user has participated. The second position is determined to be a position according to the type of the second mode of content. A user character corresponding to a related SP user is displayed in a manner (e.g., size, and color) according to the type of the second mode content.

In step S34, the process makes a determination as to whether a comment has been posted on the content from any of the participating users, that is, whether comment posting information has been received. If it is not determined that comment posting information has been received, the comment control process ends. If it is determined that the comment posting information has been received, the process proceeds to step S35 to make a determination as to whether, based on the NG-related information in FIG. 7C, the user who posted the comment is a user who satisfies the prohibition condition for the type of the related SP user who is related to the content. If it is determined in step S35 that the user who posted the comment is a user who satisfies the prohibition condition for the type of the related SP user, the comment control process ends. If it is not determined in step S35 that the user who posted the comment is a user who satisfies the prohibition condition for the type of the related SP user, the process proceeds to step S36 to make a determination as to whether multiple related SP users who are related to the content have been defined. In step S36, it is determined whether multiple related SP users are defined to be related to the content, rather than whether related SP users are participating.

If it is not determined in step S36 that multiple related SP users are defined, the process proceeds to step S37 to make a determination as to whether the received comment contains the default NG for the type of the related SP user shown in FIG. 7B or contains the individual NG for the related SP user shown in FIG. 7C. In step S37, it is determined whether a NG set for the related SP user is included, regardless of whether a related SP user is participating.

If it is not determined in step S37 that either the default NG of the type of the related SP user or the individual NG of the related SP user is included in the comment specified from the comment posting information, the process proceeds to step S38 to make a determination as to whether the comment (received comment) specified from the comment posting information includes a default NG common to all users shown in FIG. 7A. If it is not determined in step S38 that the default NG common to all users is included, the process adds the received comment to the comment history of the content for updating in step S39. In step S40, the process distributes comment information to specify the received comment to the user terminals of participating users (excluding the user terminal of the user who posted the comment). This allows the posted comment to be reflected in the virtual space. As described above, on the user terminal of the user who posted the comment, the comment is reflected in the virtual space of the content that is displayed on the user terminal of the user at the time when the comment was input.

If it is determined in step S38 that the default NG common to all users is included, the comment control process ends. This is because the second mode of content has a defined related SP user who becomes the main character/subject, and thus the topic of comments will be directed at or about the related SP user. This makes it unlikely that the topic will become conversations (comment exchanged) between participating users. In that case, there is a high probability that not reflecting comments that include default NGs will not create an awkward feeling. This reduces the processing load. Depending on the type of the second modes of content, if it is determined in step S38 that a default NG common to all users is included, a process similar to steps S21 to S23 in FIG. 8 may be performed to reflect a comment in which the part of message corresponding to the default NG is replaced with a symbol, for example, and inform the user who posted the comment of as such.

If it is determined in step S37 that either the default NG of the type of the related SP user or the individual NG of the related SP user is included in the comment specified from the comment posting information, the process proceeds to step S44 to update the NG-related information on the user who posted comment, regardless of whether the related SP user is actually participating in the content (i.e., also when the related SP user does not participate). This makes it possible to specify the NG word included in the comment and the related SP user who set the word as the NG word to be restricted (including the case of setting the type-specific NG) as NG history from the NG-related information of the user who posted the comment.

If it is determined in step S37 that either the default NG of the type of the related SP user or the individual NG of the related SP user is included in the comment specified from the comment posting information, the restriction control may be made different depending on whether the related SP user is actually participating in the content, for some types of the second mode of content. For instance, if a related SP user is not actually participating in the content, processing similar to steps S21 to S22 in FIG. 8 may be performed to reflect the comment in which the part of message corresponding to the NG word is replaced with a symbol, for example, and then the process may proceed to step S44. If a relevant SP user is actually participating in the content, the process may proceed to step S44 without reflecting the comment. This makes it possible to vary the degree of regulation and restriction depending on whether or not a related SP user is actually participating.

In step S45, the process makes a determination as to whether the prohibition condition for the related SP user is satisfied based on the NG-related information of the user who posted the comment. For instance, it is determined whether the number of times the NG word has been posted to the related SP user has reached a predetermined number. If it is not determined in step S45 that the prohibition condition is satisfied, the comment control process ends. If it is determined in step S45 that the prohibition condition is satisfied, the prohibition condition information is updated in step S46 to specify the type of related SP user who is a target of the prohibition condition being satisfied. This prevents the user who posted the comment from posting a comment within the virtual space of content that is related to a SP user of the type that is specified from the prohibition condition information.

If it is determined in step S36 that multiple related SP users are defined, the process proceeds to step S43 to make a determination as to whether the comment identified from the comment posting information contains the default NG for the type of the related SP user shown in FIG. 7B. If multiple related SP users are defined, there may be a case where even if it is a NG word for one related SP user, the other related SP user may wish to reflect it in order to enhance the atmosphere in the content, or a case where strict restriction causes too small number of comments reflected because the number of individual NG words will increase. In consideration of these cases, the individual NG of the related SP user shown in FIG. 7C, for example, is excluded from the restriction target. If the types of multiple related SP users are different, it is determined in step S43 whether any of the default NGs for each type is included. The present invention is not limited to this. If the types of multiple related SP users are different, it may be determined in step S43 as to whether a common default NG is included among the default NGs of these types, or it may be determined whether one of the default NGs is included among the default NGs of these types.

If it is not determined in step S43 that the comment specified from the comment posting information contains a default NG for type of the related SP user, the process proceeds to step S38. If it is determined that the comment contains a default NG for the type of the related SP user, the process proceeds to step S44. Note that step S43 is not limited to this as long as it may perform restriction control different from that performed when there is only one related SP user in order to prevent the number of NGs from becoming too large. For instance, the type-specific NG of the related SP user shown in FIG. 7B may be excluded from the restriction target, and it may be determined whether individual NGs set for each of the multiple related SP users are included.

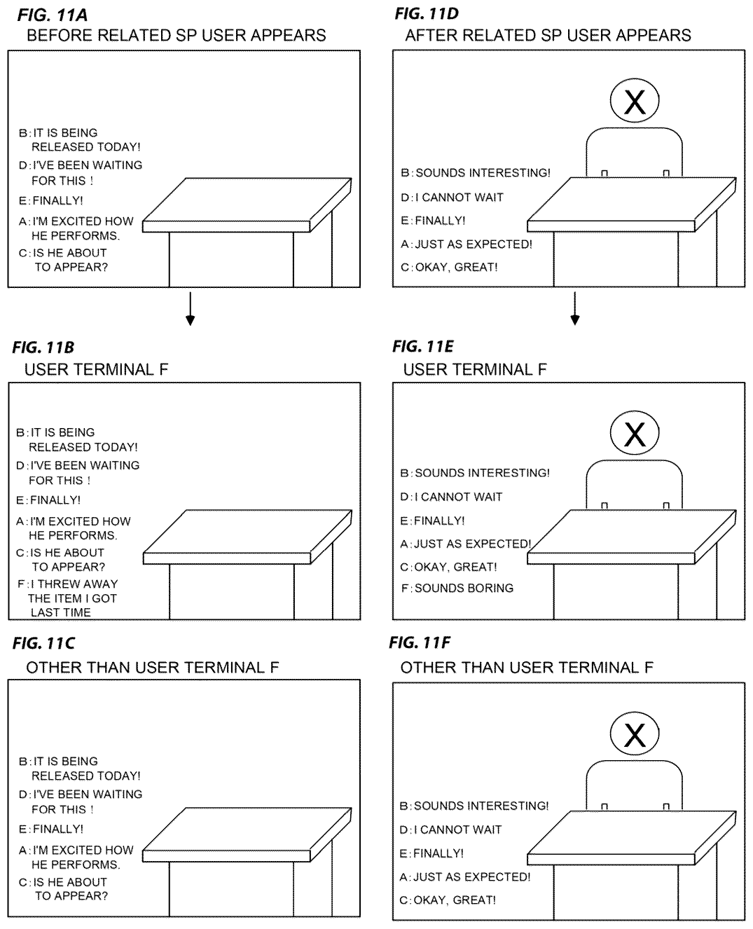

FIG. 11A through FIG. 11F illustrate display examples of a user terminal during the distribution of a second mode of content. FIG. 11A to FIG. 11F show display examples of a user terminal participating in program content of performer X, which is one of the second modes of content. For instance, this program content includes: a first part in which fans of performer X gather to exchange information about performer X before the performer X appears; and a second part in which performer X appears at a certain time (such as timing determined in advance by the operator or at any timing of performer X's choice) to further liven up the atmosphere. Performer X is a user who is defined to be related to this program content.

FIG. 11A through FIG. 11C show examples of display during the first part in which performer X has not appeared. As shown in FIG. 11A, the user terminal of a user participating in the program content displays a desk object by which performer X stands when they appear, from the center area to the right area of the screen, and displays a history of a predetermined number of comments most recently posted on the program content in the left area of the screen. Although FIG. 11A shows an example in which the user character of a participating user is not displayed in the virtual space, the user character may be displayed in the virtual space depending on the type of content.

FIG. 11A shows comments posted in the order of users B, D, E, and A from the comment history, and a comment such as “Is he about to show up?” posted by user C. When a comment is posted, the content of the comment is displayed next to the user name in the comment history. This allows the users to be informed of the most recently posted comment in an easily understandable manner.

Following the comment posted from user C, FIG. 11B shows an example of the display on user terminal F of user F when user F posted a comment such as “I threw away the item I got last time . . . ”, and FIG. 11C shows an example of the display on a user terminal of a user other than user F who posted the comment. On user terminal F of the user F who posted the comment, the posted comment is reflected in the virtual space regardless of whether the comment contains a NG word when posted it, as described above. A user terminal of a user other than the user who posted the comment receives the comment information transmitted in step S40 in FIG. 10, and has the posted comment reflected in the virtual space. It is assumed that performer X has set words that evoke negative or passive impressions as NG words, and these include “throw away” and “discard.” Furthermore, regardless of whether performer X is participating in the content (even if they have not yet participated), when a comment is posted, a determination such as step S37 in FIG. 10 is made. The comment posted by user F includes a NG word set by performer X. Thus, it is determined YES in step S37 in FIG. 10, so that comment information is not transmitted in step S40 of FIG. 10. Therefore, as shown in FIG. 11C, the comment from user F is not displayed on user terminals of users other than user F.

FIG. 11D through FIG. 11F show examples of display during the second part in which performer X appears. As shown in FIG. 11D, the user terminal of a user participating in the program content displays a desk object by which performer X stands, from the center area to the right area of the screen, and displays a history of several comments most recently posted to the program content in the left area of the screen. FIG. 11D shows comments posted in the order of users B, D, E, and A from the comment history, and a comment such as “Okay, great!” posted by user C.

Following the comment posted from user C, FIG. 11E shows an example of the display on user terminal F of user F when user F posted a comment such as “Sounds boring . . . ”, and FIG. 11F shows an example of the display on a user terminal of a user other than user F who posted the comment. On user terminal F of user F who posted the comment, the posted comment is reflected in the virtual space regardless of whether the comment contains a NG word when posted. A user terminal of a user other than the user who posted the comment receives the comment information transmitted in step S40 in FIG. 10, and has the posted comment reflected in the virtual space. It is assumed that performer X has set words that evoke negative or passive impressions as NG words, and these include “boring” and “sounds boring.” Furthermore, regardless of whether performer X is participating in the content, when a comment is posted, a determination such as step S37 in FIG. 10 is made. The comment posted by user F includes a NG word set by performer X. Therefore, as shown in FIG. 11F, the comment from user F is not displayed on user terminals of users other than user F.

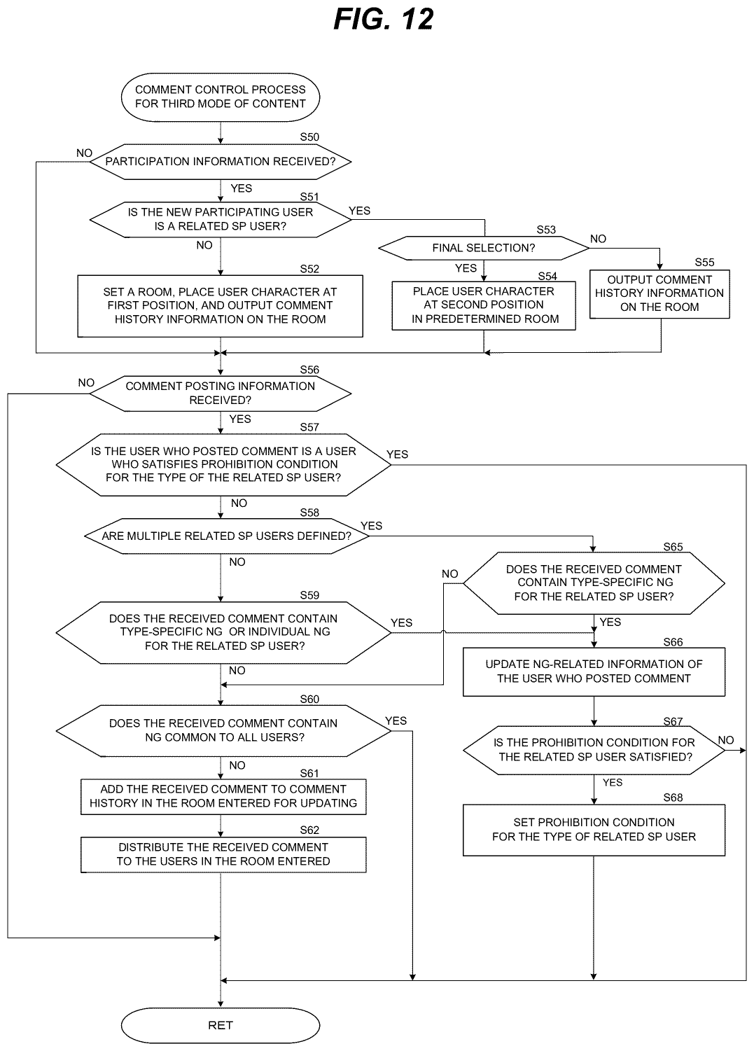

FIG. 12 is a flowchart of the comment control process during distribution of a third mode of content. The comment control process during distribution of a third mode of content is executed for each piece of content, and is repeatedly executed by the controller 130 of the distribution server 100 at predetermined time intervals. The distribution server 100 performs various processes including the comment control process during distribution of a third mode of content on the basis of the program stored in the storage unit 120.

First, in step S50, the process makes a determination as to whether participation information has been received from a user terminal. If it is not determined that participation information has been received, the process proceeds to step S56. If it is determined that the participation information has been received, the process makes a determination in step S51 as to whether the new participating user is a related SP user (e.g., distribution user, or SP user) who is a user who becomes the main character or the subject of the content being distributed and is relevant to the content. In step S51, it is determined whether the user ID is of the related SP user, which is stored for each piece of content shown in FIG. 6C.

If the user is not determined to be a related SP user in step S51, the process proceeds to step S52. Then, the process sets and stores a room to which the user is to enter among multiple rooms corresponding to the content (see FIG. 6C), and places a user character corresponding to the user at a first position (e.g., an audience seat) in the virtual space of the room, and outputs comment history information for specifying the comment history of the room (see FIG. 6C) to the user terminal of the participating user. This allows the content data in which the user character of the newly participating user is placed in the virtual space of the room to be distributed, and allows the user character to be reflected and displayed at the first position in the virtual space in the room on the user terminal of a user who is in the room (is participating) in the content. Furthermore, the user terminal of the newly participating user receives the comment history information and thereby specifies and displays the comment history posted in the content in which the user has participated. The first position is determined to be a position according to the type of the third mode of content. A user character corresponding to a user who is not a related SP user is displayed in a manner (e.g., size, and color) according to the type of the third mode content, and may not be displayed depending on the type of content.

If the user is determined to be a related SP user in step S51, the process proceeds to step S53 to make a determination as to whether the user enters the selected room (i.e., whether the selection is final). For the third mode of the content, an example is shown, in which a related SP user is allowed to select the room they want to enter. Specifically, they provisionally select one of the rooms, check the room including the comment history, and then make a final selection to enter the room.

If it is not determined in step S53 that the selection is final, then this is a provisional selection for the purpose of checking the room and others. Thus, the process proceeds to step S55 to output comment history information for specifying the comment history (see FIG. 6C) of the provisionally selected room to the user terminal of the related SP user. Then, the process proceeds to step S56. This allows the user terminal (distribution user terminal 400 in this case) of the related SP user who made a provisional selection to receive the comment history information and thereby specify and display the comment history posted in the provisionally selected room. Furthermore, while the related SP user is checking the provisionally selected room, the user character of the related SP user will not be displayed in the room. This allows the related SP user, who made a provisional selection, to check each of the multiple rooms without displaying their user character in the rooms. The room that is provisionally selected first may be one selected by the related SP user, or may be one selected by the distribution server 100. When selected by the distribution server 100, the room with the largest number of users may be selected, or the room with a predetermined number (e.g., 20) or more users in the room may be randomly selected. This will make it easier for the related SP user to understand the level of interaction and excitement within the provisionally selected room based on the status of comment postings, for example. The related SP user may provisionally select a room and check the room, and then provisionally select another room to change the room to be checked.

If it is determined in step S53 that the selection is final, then the process proceeds to step S54 to place a user character corresponding to the related SP user who made a final selection at a second position (e.g., on the stage, and on the platform) in the virtual space of the predetermined room. Then, the process proceeds to step S56. This allows the content data in which the user character of the newly participating related SP user is placed in the virtual space of the predetermined room, and allows the user character of the related SP user, who becomes the main character or the subject, to be reflected and displayed at the second position in the virtual space of each room on the user terminals of users who are in the predetermined room.

The related SP user finally selects the provisionally selected room, which makes the user character of the related SP user displayed in the predetermined room as described above. The predetermined room in which the user character of the related SP user is displayed is defined according to the type of content. For live event content, for example, a plurality of rooms corresponding to the live event content are all set as predetermined rooms, and the user character of the related SP user is mirrored in each of the plurality of rooms and reflected in each room. For fan meeting content, for example, a room finally selected by a particular performer, for example, is set as a predetermined room, and the user character of the related SP user is reflected only in the room. Even after the final selection, this final selection may be cancelled, and another room may be provisionally selected for the final selection (change the selected room). After the final selection, until the cancellation of the final selection and a provisional selection of another room for the final selection, the display of the user character of the related SP user may be maintained for live event content. For fan meeting content, the user character of the related SP user may be made invisible in response to the cancellation of the final selection, and then the user character may be reflected in the finally selected room.

The comment history of the finally selected room has already been displayed in step S55 on the user terminal of the relevant SP user. The second position is determined to be a position according to the type of the third mode of content. The user character corresponding to the related SP user is displayed in a manner (e.g., size, and color) according to the type of the third mode content. Note that, after the content starts, if the related SP user makes a provisional selection to check the virtual space of the content, including the comment history, and then makes a final selection to make the user character appear in the virtual space, then steps S53 to S55 in FIG. 12 may not be executed (the room cannot be selected again). Steps S53 to S55 in FIG. 12 may be applied to the second mode of content described above. For the second mode of content, the related SP user may make a provisional selection to check the virtual space of the content, including the comment history, and then make a final selection to make the user character appear in the virtual space, for example.

In step S56, the process makes a determination as to whether a comment has been posted in any of the rooms, that is, comment posting information has been received, regardless of whether this is the room which the related SP user has selected and entered. If it is not determined that comment posting information has been received, the comment control process ends. If it is determined that the comment posting information has been received, the process proceeds to step S57 to make a determination as to whether, based on the NG-related information in FIG. 7C, the user who posted the comment is a user who satisfies the prohibition condition for the type of the related SP user who is related to the content. If it is determined in step S57 that the user who posted the comment is a user who satisfies the prohibition condition for the type of the related SP user, the comment control process ends. If it is not determined in step S57 that the user who posted the comment is a user who satisfies the prohibition condition for the type of the related SP user, the process proceeds to step S58 to make a determination as to whether multiple related SP users who are related to the content have been defined.

If it is not determined in step S58 that multiple related SP users are defined, the process proceeds to step S59 to make a determination as to whether the received comment contains the default NG for the type of the related SP user shown in FIG. 7B or contains the individual NG for the related SP user shown in FIG. 7C.

If it is not determined in step S59 that either the default NG of the type of the related SP user or the individual NG of the related SP user is included in the comment specified from the comment posting information, the process proceeds to step S60 to make a determination as to whether the received comment includes a default NG common to all users shown in FIG. 7A. If it is not determined in step S60 that a default NG common to all users is included, the process proceeds to step S61 to add the received comment to the comment history of the room in which the user who posted the comment is participating for updating. In step S62, comment information for specifying the received comment is distributed to user terminals of users (excluding the user terminal of the user who posted the comment) participating in the same room (the room in which the user who posted the comment is present). This allows the posted comment to be reflected in the virtual space of the same room as the user who posted the comment. As described above, on the user terminal of the user who posted the comment, the comment is reflected in the virtual space of the room displayed on the user terminal of the user at the time when the comment was input.

If it is determined in step S60 that a default NG common to all users is included, the comment control process ends. This is for the same reason as explained in step S38 of FIG. 10. Depending on the type of the third mode of content, if it is determined in step S60 that a default NG common to all users is included, a process similar to steps S21 to S23 in FIG. 8 may be performed to reflect a comment in which the part of message corresponding to the default NG is replaced with a symbol, for example, and inform the user who posted the comment of as such.

If it is determined in step S59 that the received comment contains a default NG for the type of the related SP user or an individual NG for the related SP user, the process proceeds to step S66 to update the NG-related information on the user who posted the comment, regardless of whether the related SP user is actually participating in the content, and even if the related SP user is participating, regardless of whether the post is from a user who is in the same room as the related SP user. This makes it possible to specify the NG word included in the comment and the related SP user who set the word as the NG word to be restricted (including the case of setting the type-specific NG) as NG history from the NG-related information of the user who posted the comment.

If it is determined in step S59 that either the default NG of the type of the related SP user or the individual NG of the related SP user is included in the comment specified from the comment posting information, the restriction control may be made different depending on whether the related SP user is actually participating in the content, for some types of the third mode of content. For instance, if a related SP user is not actually participating in the content, processing similar to steps S21 to S22 in FIG. 8 may be performed to reflect the comment in which the part of message corresponding to the NG word is replaced with a symbol, for example, and then the process may proceed to step S66. If a relevant SP user is actually participating in the content, the process may proceed to step S66 without reflecting the comment. This makes it possible to vary the degree of regulation and restriction depending on whether a related SP user is actually participating.

In step S67, the process makes a determination as to whether the prohibition condition for the related SP user is satisfied based on the NG-related information of the user who posted the comment. If it is not determined in step S67 that the prohibition condition is satisfied, the comment control process ends. If it is determined in step S67 that the prohibition condition is satisfied, the prohibition condition information is updated in step S68 to specify the type of related SP user who is a target of the prohibition condition being satisfied. This prevents the user who posted the comment from posting a comment within the virtual space of content that is related to a SP user of the type that is specified from the prohibition condition information.

If it is determined in step S58 that multiple related SP users are defined, the process proceeds to step S65 to make a determination as to whether the comment contains the default NG for the type of the related SP user shown in FIG. 7B. This is for the same reason as explained in step S43 of FIG. 10. If it is not determined in step S65 that the received comment contains a default NG for type of the related SP user, the process proceeds to step S60. If it is determined that the comment contains a default NG for the type of the related SP user, the process proceeds to step S66.

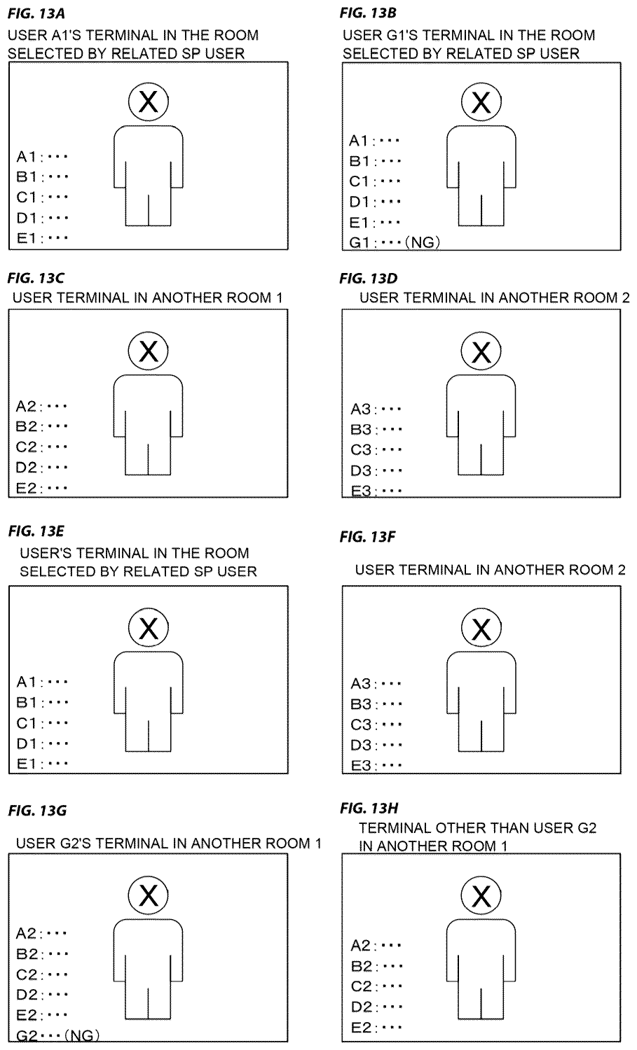

FIG. 13A through FIG. 13H illustrate display examples of a user terminal during the distribution of a third mode of content. FIG. 13A to FIG. 13H show display examples of user terminals of a plurality of users participating in live event content by performer X, which is one of the third modes of content. In the live event content, as shown in FIG. 13A, for example, a user character of performer X as the main character is placed in the center area of the screen, and the history of a predetermined number of comments most recently posted to the room in which the user of the user terminal is displayed on the left area of the screen. In the live event content, the user character of performer X is mirrored and reflected in all of the multiple rooms corresponding to that content.

FIG. 13A shows a display example of a user terminal of user A1 who is in the same room as the room selected by performer X, and FIG. 13B shows a display example of a user terminal of user G1 who is in the same room as the room selected by performer X. It is assumed that users A1 to Z1 have entered the room selected by performer X. The comment history shown in FIG. 13A shows that comments were posted by users A1, B1, C1, D1, and E1 in that order.

FIG. 13C and FIG. 13D show a display example of a user terminal of a user who has entered a room different from the room selected by performer X. It is assumed that, as shown in FIG. 13C, users A2 to Z2 have entered room 1 that is different from the room selected by performer X. The comment history shows that comments were posted by users A2, B2, C2, D2, and E2 in that order. It is assumed that, as shown in FIG. 13D, users A3 to Z3 have entered room 2 that is different from the room selected by performer X. The comment history shows that comments were posted by users A3, B3, C3, D3, and E3 in that order.

The following describes a case, as shown in FIG. 13B, where user G1, who is in the same room as the room that performer X has selected, posts a comment containing the NG word that performer X has set. On user terminal of user G1 who posted the comment, the posted comment is reflected in the virtual space regardless of whether the comment contains a NG word when posted it, as described above. A user terminal of a user other than the user who posted the comment and who is in the same room (including performer X) receives the comment information transmitted in step S62 in FIG. 12, and reflects the posted comment in the virtual space. However, the comment posted by user G1 contains a NG word set by performer X, and thus it is determined YES in step S59 of FIG. 12 and comment information is not transmitted in step S62 of FIG. 12. Thus, on the user terminal of a user who is in the same room as user G1, the comment from user G1 is not displayed, as shown in FIG. 13A. For a user terminal of a user who is in a different room from user G1, the comment from user G1 will not be displayed as shown in FIG. 13C and FIG. 13D, regardless of whether the comment posted by user G1 contains a NG word.

FIG. 13E to FIG. 13H show a case immediately before the comment from user G1 shown in FIG. 13B is posted, and when a comment including a NG word set by performer X was posted by user G2 who is in room 1 different from the room that performer X has selected. On user terminal of user G2 who posted the comment, as shown in FIG. 13G, the posted comment is reflected in the virtual space regardless of whether the comment contains a NG word when posted it.

A user terminal of a user other than the user who posted the comment and who is in the same room receives the comment information transmitted in step S62 in FIG. 12, and reflects the posted comment in the virtual space. However, the comment posted by user G2 contains a NG word set by performer X, and thus it is determined YES in step S59 of FIG. 12 and comment information is not transmitted in step S62 of FIG. 12. Thus, on the user terminal of a user who is in the same room as user G2, the comment from user G2 is not displayed, as shown in FIG. 13H. Note that, for a user terminal of a user who is in a different room from user G2, the comment from user G2 will not be displayed as shown in FIG. 13E and FIG. 13F, regardless of whether the comment posted by user G2 contains a NG word.

### Example of Specific Configurations and Advantageous Effects

(1-1) In the above embodiment, in accordance with a program (e.g., a program stored in a non-transitory computer-readable storage medium) stored in the distribution server computer 100 and a user terminal, during distribution of any of first modes of content, if it is determined that no SP user is participating in a virtual space of the content in step S15 of FIG. 8, and even if the posted comment includes a NG word set for any SP user, the received comment is reflected in the virtual space in step S20 of FIG. 8. In contrast, during distribution of any of first modes of content, if it is determined that a SP user is participating in a virtual space of the content in step S15 of FIG. 8 (including the case where a SP user, who was not participating, is participating there), and if the posted comment includes a NG word set for the SP user who is participating, the process determines YES in step S17 of FIG. 8, and reflection of the received comment in the virtual space is restricted. This enables appropriate restriction of the reflection of a comment including a NG word set for the SP user, depending on whether the SP user is included in the virtual space of the content.

(1-2) In the above embodiment, the comment posted in the content is added to the comment history for updating in step S19 of FIG. 8, for example. If a new user participates in the content, comment history information is output to the user terminal of the user to enable the comment history to be displayed in step S12 of FIG. 8. If a SP user who has not participated in the content newly participates, a comment including a NG word set for the SP user is deleted from the comment history for updating in step S13 of FIG. 8, and the comment history information after the deletion and updating is output. This prevents the comment history including the NG word from being reflected and displayed on the SP user's user terminal when the SP user newly participates.

(1-3) The above embodiment describes an example where the NG setting unit 253 sets a NG word candidate that is proposed from a SP user who is participating in the virtual space of certain content (including the case where the user themselves is distributing the content) as a NG word for such SP user without waiting for the setting from the operator. The above example shows that, with the input information transmission unit 356, the SP user themselves drags and highlights a part of the message to be used as a candidate NG word from the comment reflected in the comment history in the virtual space of the content in which they are participating, thus applying for setting the NG word. These reduce the time and effort required to set a NG word and improve convenience for a SP user.

(2-1) In the above embodiment, in accordance with a program (e.g., a program stored in a non-transitory computer-readable storage medium) stored in the distribution server computer 100 and a user terminal, if a comment including a NG word set for any SP user is posted by multiple users participating in a first mode content that is not related to the SP user and does not satisfy a special condition for the SP user, and if the SP user is not actually participating, the comment is reflected in the virtual space of the content in step S20 of FIG. 8. In contrast, if a comment including a NG word set for any SP user is posted by multiple users participating in a second mode of content or a third mode content that is related to the SP user and satisfies a special condition for the SP user, it is determined YES in step S37 of FIG. 10, regardless of whether the SP user is actually participating, and thus reflection of the comment including the NG word is restricted in the virtual space of the content. This appropriately restricts the reflection of a NG word set for a SP user according to the type of content.

(2-2) The above embodiment shows an example of content that satisfies the special condition, including content where a related SP user appears there to initiatively distribute the content, and content where a related SP user does not appear and fans of the related SP user gather to communicate with each other. In any type of the content, it makes it possible to prevent a NG word from being reflected before the relevant SP user is included in the content, or a NG word from being reflected if the content is predetermined to be relevant to the SP user.

(2-3) In the above embodiment, content related to a SP user belonging to SP1 and content related to a SP user belonging to SP2 contain different words as NG words. This allows NG words to be appropriately differentiated according to the type of related SP user and content type.

(3-1) In the above embodiment, in accordance with a program (e.g., a program stored in a non-transitory computer-readable storage medium) stored in the distribution server computer 100 and a user terminal, if it is determined Yes in step S37 of FIG. 10, for example, the reflection of the received comment is restricted, and the NG-related information of each user is updated in step S44 of FIG. 10. Further, if it is determined based on the NG-related information in step S35 of FIG. 10, for example, that the user who posted the comment is a user who satisfies the prohibition condition for the type of the related SP user, the reflection of the comment is restricted, regardless of whether the comment contains a NG word or whether the SP user who caused the prohibition condition to be satisfied is participating. In this way, NG-related information updated for each user is utilized in the content that is relevant to SP users belonging to the same type, and reflection of a comment from a prohibited user who satisfies the prohibition condition according to NG-related information is restricted.

(3-2) In the above embodiment, for example, if a prohibited user who satisfies the prohibition conditions for SP1 is included among users participating in content related to SP users belonging to SP2, and when a comment is posted from the prohibited user, the comment from the prohibited user is reflected if the prohibition condition for SP2 is not satisfied. This prevents NG-related information updated for each user from being utilized and used also for content that is relevant to SP users belonging to different types, and prevents excessive restrictions of the reflection.

(4-1) In the above embodiment, in accordance with a program (e.g., a program stored in a non-transitory computer-readable storage medium) stored in the distribution server computer 100 and a user terminal, in content that satisfies a special condition for any SP user, if a comment containing a NG word set for the SP user is posted, the reflection of the comment is restricted, and a type-specific NG is set in advance for a type of SP users, where different words are included between for a SP user belonging to type SP1 and a SP user belonging to type SP2. This allows appropriate restriction of words according to the type of a SP user without the trouble in setting NG words.

(4-2) In the above embodiment, for example, assume a situation where related SP users who are defined to be relevant to the content include a SP user belonging to type SP1 and a SP user belonging to type SP2. As exemplified in step S43 of FIG. 10, the reflection is restricted based on the type-specific NG, not based on individual NG words that are set individually for each of the multiple SP users. In this way, the process for restricting the reflection (restriction control) may be different depending on whether multiple related SP users are included.

(5-1) In the above embodiment, in accordance with a program (e.g., a program stored in a non-transitory computer-readable storage medium) stored in the distribution server computer 100 and a user terminal, in a third mode of content in which multiple rooms (multiple virtual spaces) are prepared to provide a single piece of content, if a comment containing an NG word is posted in one of the rooms, the reflection of the comment is restricted regardless of whether the comment was posted in a room selected by a related SP user of the content. This enables appropriate restriction of the reflection of a comment containing a NG word also in the third mode of content.

(5-2) For the case of live event content in the above embodiment, an example is shown, in which a user character corresponding to the related SP user is displayed in all multiple rooms corresponding to the live event content, regardless of whether the room is selected by the related SP user. This allows users entering any room to recognize and see the user character corresponding to the related SP user, thus creating a sense of unity in all rooms.

(5-3) For the case of fan meeting content in the above embodiment, an example is shown, in which a user character corresponding to the related SP user is displayed in the room selected by the related SP user. This increases the sense of anticipation and premium feeling regarding the display of the user character corresponding to the related SP user.

(5-4) In the above embodiment, as shown in step S55 of FIG. 12, the related SP user is able to check the state including the comment history in the provisionally selected room. Also, as shown in step S54 in FIG. 12, the user character corresponding to the related SP user is not displayed until the related SP user makes a final selection. This allows the related SP user to understand the state of a room without being aware of the user character by other users in the room, and the related SP user is able to use this for a reference as to whether or not to select this room and enter the room.

(5-5) The above embodiment shows an example, in which when the distribution server 100 selects a room to be provisionally selected first, it may select the room with the largest number of users, or may randomly select a room with a predetermined number (e.g., 20) or more users in the room. This will make it easier for the related SP user to understand the level of interaction and excitement within the provisionally selected room based on the status of comment postings, for example.

(5-6) The above embodiment shows an example, where after provisionally selecting a room and checking it, the user is able to provisionally select another room and change the room to be checked, and that even after a room has been finally selected, the user is able to cancel the final selection and provisionally select another room and change the room to be selected (change the selected room). This allows a related SP user to change the rooms to be checked one after another, thereby improving the convenience of the related SP user.

(6) The above embodiment shows an example, in which a user who has a specific relationship includes a participating user (a user who participates in a group of certain content) associated with common content (group). This enables restriction of the reflection of a NG word among users associated with common content.

(7) In the above embodiment, during distribution of a first mode of content, if a default NG common to all users is included in the received comment, the default NG of the comment is replaced with a symbol, for example, in step S22 of FIG. 8, and the comment other than the default NG is reflected. If a NG word set for a participating SP user is included in the received comment, it is determined YES in step S17 of FIG. 8 to restrict the reflection of the comment itself including the NG word. This will restrict the reflection of a predefined default NG common to all users to a minimum extent, and thus prevents inconveniences such as a failure to carry on the conversation because reflection of a comment that contains a word that the SP user has not specified as a restriction target is restricted.

(8) In the above embodiment, during distribution of a second mode of content or a third mode of content, if it is determined in step S37 of FIG. 10 that either the default NG of the type of the related SP user or the individual NG of the related SP user is included in the comment specified from the comment posting information, and if the related SP user is not actually participating, the process similar to steps S21 to S22 of FIG. 8 is performed to reflect a comment with the part of message corresponding to the NG word with a symbol, for example, and the process proceeds to step S44. If it is determined in step S37 of FIG. 10 that either the default NG of the type of the related SP user or the individual NG of the related SP user is included in the comment specified from the comment posting information, and if the related SP user is actually participating the content, the process proceeds to step S44 without reflecting the comment itself. This makes it possible to, during distribution of a second mode of content or a third mode of content, vary the degree of restriction depending on whether a related SP user is actually participating.

(9) In the above embodiment, when a SP user performs an operation to apply for setting a new NG word, and if the application is accepted by the operator, this candidate is set as an individual NG for the SP user by the NG setting unit 253. This prevents the use of too many NG words because a word that is accepted by the operator is set as a NG word.

(10) In the above embodiment, as shown in FIG. 8, for example, NG words include: a default NG common to all users, where, if the reflection of a default NG is restricted, the user who posted the comment including the word is notified of the restriction; and an individual NG, where the user is not informed of the restriction. In step S23 of FIG. 8, a process is performed to inform the user who posted the comment containing the default NG common to all users that reflection of the comment has been restricted because it is a NG. This will prevent repeated posting of the default NG common to all users.

(11) In the above embodiment, the comment is reflected on the user terminal of the user who posted the comment, regardless of whether the comment contains an NG word, and the comment posting information is output to the user terminal (e.g., see FIG. 9E), while the distribution server 100 outputs comment information for a comment that does not contain a NG word to reflect the comment in the virtual space of the content, but does not output comment information for a comment containing a NG word to restrict the reflection (e.g., see FIG. 9F). This prevents the user who posted the comment from being able to know whether the comment was actually reflected, and thus prevents the user from specifying the NG word and posting a comment in a way that circumvents the restrictions.

(12) In the above embodiment, a common default NG is set in advance for each type of SP user as shown in FIG. 7B. For instance, an example is shown, in which between step S16 and step S17 of FIG. 8, a determination may be made whether the content includes a plurality of SP users. In this example, if it is not determined that the content includes a plurality of SP users, the process proceeds to step S17, and if it is determined that a plurality of SP users is included, then the process makes a further determination as to whether the received comment contains a type-specific NG for each of these SP users, and if the type-specific NG is not included, the process proceeds to step S18. If the type-specific NG is included, the process may restrict the reflection and proceed to step S24. This prevents too few comments reflected when multiple SP users are included.

(13) In the above embodiment, when a related SP user is included among the participating users, the actions that the related SP user may take are different from the actions (e.g., posting a comment) that can be taken by users (e.g., general users or other SP users) other than the related SP user. For example, when the related SP user is initiatively distributing content, the related SP user cannot post comments, but is able to make a corresponding user character, like an avatar of the related SP user, move and output sound in the virtual space. This makes the actions that can be taken by a related SP user and other users different, allowing each user to take an action appropriate to their situation.

### Modification Examples

The following is a list of modification examples and others of the embodiments described above.

(1) The above embodiment describes an example in which when a SP user newly participates in the virtual space of a first type of content, if the NG word (e.g., individual NG, type-specific NG) set for the SP user is included in step S13 of FIG. 8, the comment including the NG word is deleted for updating from the comment history, and the comment history information to specify the updated comment history is output in step S12. The present invention is not limited to this. When a SP user newly participates in the virtual space of the first mode content, the comment history may be updated according to the type of a NG word set for the SP user so that the comment corresponding to the action belonging to a first type is kept, while the comment corresponding to the action belonging to a second type is deleted for updating, and the comment history information for specifying the updated comment history may be output. For example, among the NG words set for the SP user, a type-specific NG word set for the type of the SP user may be defined as a first type of NG word, and an individual NG word set individually by the SP user may be defined as a second type of NG word. Then, when the SP user newly participates in the virtual space of the first mode of content, a comment including the type-specific NG word of the first type may be kept, while a comment including an individual NG word of the second type may be deleted to update the comment history, and the comment history information for specifying the updated comment history may be output. This makes it possible to more precisely determine whether to reflect or restrict a comment in accordance with the types of NG word when a SP user newly participates in the virtual space of the first mode of content. Note that the first type of NG words and the second type of NG words are not limited to this example. For example, when setting NG words, a first rank or a second rank may be set for each NG word depending on the meaning of the word, and NG words set to the first rank may be defined to be NG words of the first type, and NG words set to the second rank may be defined to be NG words of the second type.

(2) The above embodiment describes an example, in which users who participate in a group of content that the users are allowed to view and experience the content are users who have a specific relationship. The present invention is not limited to this. A virtual space or user characters are not displayed, and for example, users who participate in a message exchanging group (e.g., a group chat, and a mailing list) set up so that messages can be exchanged between multiple people may be users who have a specific relationship. In content in which a user character corresponding to a user placed in the virtual space is moved in response to the user's operation, it may be assumed that the user character corresponding to a user is placed within a predetermined range is the user who has a specific relationship. The predetermined range may be, for example, within a circle with a radius of 10 m in the virtual space, or a range that changes from time to time to include a specified number of users (e.g., 20 or 100), or may be defined differently depending on the type of content or virtual space. This allows the reflection of a NG word to be restricted among users who are participating in the same content and whose user characters are placed within a predetermined range, thereby preventing the restriction range from becoming too large.

(3) The above embodiment describes an example, in which the distribution server 100 restricts the reflection of an individual NG word set for a SP user, whereas it does not set and restrict a NG word for each of general users who are not SP users. Also for general users who are not SP users, the distribution server 100 may set a NG word for each general user upon request from the general user to set the NG word. In this case, the distribution server 100 may restrict the reflection of such a NG word for each general user only within a host room (virtual space) that is relevant to the general user, such as a room opened (hosted) by the general user themselves, and in which other users (e.g., friend users) are able to participate. This prevents excessive restriction of such a NG word set for the general user even when the word is not relevant to the general user.

(4) As shown in step S18 of FIG. 8, step S35 of FIG. 10, step S57 of FIG. 12, and others, in the above embodiment, based on the NG-related information in FIG. 7C, it is determined whether the user who posted the comment is a user who satisfies the prohibition condition for the type (hereinafter, SP1) of the related SP user. If the user is a user who satisfies the prohibition condition (hereinafter referred to as a prohibited user), the reflection of a comment posted by the prohibited user is restricted, regardless of whether the comment contains a NG word, and regardless of whether a SP user who caused the prohibition condition to be satisfied (e.g., a SP user, with respect to which the number of restriction has reached a predetermined number of times, hereinafter referred to as a prohibition source SP user) is participating. The above embodiment describes an example in which, when a related SP user who is related to the content that the prohibited user is viewing and experiencing is a user of a different type (hereinafter, SP2) from the type that satisfies the prohibited condition, the reflection of a comment posted by the prohibited user will not be restricted simply by satisfying the prohibition condition. In this case, it may be possible to notify a related SP user of SP2 who is related to the content that the prohibited user is viewing/experiencing of the information that enables identification of the prohibition source user who caused the prohibition condition to be satisfied (e.g., the distribution server 100 may output information to display a message on the user terminal of the related SP user, such as “This user has reached a predetermined number of NG actions against a prohibition source SP user belonging to SP1”). It may be also possible to notify a related SP user of SP2 who is related to the content that the prohibited user is viewing/experiencing of the information that enables identification of the NG word, about which the prohibited user has satisfied the prohibition condition and whose reflection is restricted (e.g., the distribution server 100 may output information to display a message on the user terminal of the related SP user, such as “This is the NG word that the prohibition user has posted). This calls the attention of the related SP user of SP2.

If the above-mentioned prohibited user participates in content with which a related SP user of SP2 is related and posts the NG word, and thus satisfies the prohibition condition for the related SP user of SP2. Then, the prohibited user may satisfy prohibition conditions for a predetermined number or more (e.g., two, three, and more) of types. In this case, it also may be possible to restrict the reflection of a comment posted by the prohibited user in content that is related to a related SP user of a type with respect to which the prohibited user does not satisfy the prohibition condition. This identifies a user as being clearly malicious if the user satisfies prohibition conditions for the predetermined number or more of types, and prevents this prohibited user from posting comments, regardless of the type of related SP user, thus preventing the damage from spreading.

It may also be possible to cancel (e.g., reset the number of restrictions) the prohibition condition satisfied by the prohibited user, in response to an operation from the prohibition source user who caused the prohibition condition to be satisfied or from the operator. This prevents a situation in which the prohibited user satisfies the prohibition condition continuously, and thus the comment posting from this prohibited user is continuously restricted.

(5) The above embodiment describes an example, in which an individual NG word can be set based on a request to set the NG word in response to an operation from a SP user, while the default type-specific NG word for each type of SP user cannot be changed. This allows an individual NG to be customized according to the SP user's intention, thus improving the convenience. Whereas, this does not allow a type-specific NG to be changed, thus making it easier for the operator to manage the level of restrictions on the type-specific NG. The present invention is not limited to this, and a default type-specific NG type that is a default for each type of SP users may also be set for each SP user in response to an operation from the SP user. In this case, for example, the operator sets a type-specific NG as default for each type of SP users, and uniformly reflects it as the default NG information for each SP user (e.g., storing this type-specific NG in association with information on each user as in FIG. 7C), and thereafter not only individual NG but also type-specific NG stored in association with the information on each user may be customized (e.g., to exclude from the restriction), based on a request to set NG words in response to an operation by the SP user. This allows a SP user to customize not only individual NG but also type-specific NG according to their intention, thus improving convenience.

(6) The above embodiment exemplifies comment posting that is an action that a user can take and that is to be restricted. The actions that a user can take and that are to be restricted are not limited to this, and instead of or in addition to this, examples of the actions include: actions of changing the position, orientation, and tilt of a virtual camera that is placed in the virtual space and can be operated by the user; actions of changing decorative objects (e.g., costume objects) of the user character placed in the virtual space; actions of emoting; actions of discarding owned objects; and actions of providing money, game value, or rewards, which may be set as appropriate.

Among the actions of changing the position, orientation, and tilt of a virtual camera, the actions to be restricted include: restricting the entry position of the virtual camera to outside a specified range (stage); and restricting the orientation to a specified orientation. Among the actions of changing the decorative objects (e.g., costume objects) of a user character to be placed in the virtual space, the actions to be restricted include: changing to a costume object that stands out more prominently than the content distributor or changing to a costume object that is more revealing.

Among the actions of emoting, the actions to be restricted include attacking a fallen user object, or repeating the same action. Among the actions of discarding an owned object, the actions to be restricted include discarding an object provided by a SP user within content in which the SP user is a related SP user. Among the actions of providing money, gaming value, or rewards, the actions to be restricted include providing a reward to only one SP user in the content in which multiple SP users participate. Note that the actions to be restricted are set by a user as appropriate, as in the above embodiment, and thus are not limited to these.

(7) The above embodiment shows an example of satisfying the prohibition condition in step S25 of FIG. 8, that is the number of times that a NG word has been posted to a SP user has reached a predetermined number. The present invention is not limited to this as long as it is determined based on NG-related information. For instance, a rank of the NG word (e.g., one NG word that satisfies the prohibition condition when it is posted once or another NG word that satisfies it when it is posted three times) may be set based on the degree of influence, and whether or not the prohibition condition is satisfied may be determined based on other parameters such as the NG-related information and the rank. In addition, the above embodiment shows an example, in which whether or not the prohibition condition is satisfied is determined based on NG-related information for one SP user. The present invention is not limited to this. It may be determined based on NG-related information on SP users of the same type (e.g., determined based on the total number of NGs for SP users of SP1) or based on NG-related information on all SP users regardless of their type (e.g., determined based on the total number of NGs for all SP users).

The above embodiment describes an example in which if a type-specific NG or individual NG is included in step S17 of FIG. 8, in step S43 of FIG. 10, in step S65 of FIG. 12, and others, NG-related information is updated in step S24. The present invention is not limited, and only if a type-specific NG or individual NG is included in step S17 of FIG. 8, NG-related information is updated in step S24.

(8) The above embodiment describes an example, in which it is determined in step S17 of FIG. 8, for example, whether or not the NG word that has been set is included. When determining whether or not the NG word is included, a determination may be made as to whether the NG word that has been set is included as it is, or instead of or in addition to this, a determination may be made as to whether a word related to the NG word that has been set (an action related to the set action) is included. A word related to the set NG word may include a word that partially match the set NG word, a word that has the same meaning as the set NG word, a word that has an inflected form of the set NG word (e.g., a word that is a five-tier conjugation), and a word that does not matter whether they are double-byte and single-byte characters.

(9) The above embodiment describes an example, in which the distribution server 100 is capable of providing content of the first to third modes. The present invention is not limited to this, and the distribution server 100 may be capable of providing content of any one mode, or of providing content of two modes, or of providing content of another mode as well.

The above embodiment describes an example, in which during distribution of any one of the first modes of content, when a SP user, who did not participate, participates in the content, the reflection of a NG word set for the SP user is restricted. In this case, when such a SP user who had been participating has left, the restriction on the reflection of the NG word set for the SP user may be lifted. In addition, assuming a temporary exit of the SP user, the restriction on the reflection of the NG word set for the SP user may be continued. In this case, the restriction on the reflection of a NG word set for the SP user may be continued until a predetermined period of time (e.g., five minutes) has elapsed since the SP user's exit, and the restriction may be lifted after the predetermined time has elapsed.

The above embodiment describes an example, in which during distribution of either a second or third mode of content, the reflection of a NG word set for a related SP user is restricted regardless of whether the related SP user is participating or not. Here, even if the related SP user leaves after participating, the restriction on reflecting the NG word set for the related SP user may continue. If the related SP user has left, the restriction on the reflection of the NG word set for the related SP user may be lifted. In this case, the restriction on the reflection of a NG word set for the related SP user may be continued until a predetermined period of time (e.g., five minutes) has elapsed since the related SP user's exit, and the restriction may be lifted after the predetermined time has elapsed.

### [Examples of Software Implementation]

The various control blocks of the controller of a computer such as a server or terminal in the above-mentioned embodiments may be implemented by a logic circuit (hardware) formed in an integrated circuit (IC chip), or may be implemented by software using a central processing unit (CPU). When the control blocks are implemented by software using a CPU, the computer having the controller includes a CPU that executes the instructions of a program, which is software that implements various functions, a read only memory ROM) or storage device (these are referred to as “recording media”) in which the program and various data are recorded so as to be readable by the computer (or CPU), and a random access memory (RAM) in which the program is expanded. Then, when the computer (or CPU) reads and executes the program from the above recording medium, the aim of the present invention is achieved. The recording medium may be a “non-transitory tangible medium” such as a tape, a disk, a card, a semiconductor memory, or a programmable logic circuit. The program may be supplied to the computer via any transmission medium (e.g., a communication network or broadcast waves) capable of transmitting the program. One aspect of the present invention can also be implemented in the form of a data signal embedded in a carrier wave, in which the above program is embodied by electronic transmission.

### Addendum 1

A known system for distributing content via a network includes one that distributes a video in which a virtual character (avatar) appears in a virtual space and acts in response to the distributor. Another known system reflects comments and other actions received from viewers watching a video distributed in a virtual space, but limits or restricts the reflection of actions that the distributor has set as undesirable (see, for example, Patent Literature 1).

In conventional services, when a virtual character corresponding to a distributor actually appears, the reflection of actions that the distributor has set as undesirable is restricted. This means that even in a virtual space where a virtual character corresponding to the distributor is supposed to appear, the set actions would be reflected without proper restriction before the virtual character actually appears. Also in a virtual space where fans of the distributor gather (even though a virtual character corresponding to the distributor does not appear), the actions that the distributor sets may be reflected without any restrictions, and such a reflection is not desirable for the distributor.

In view of the above, the present invention described in the above embodiment and modified examples provides a method and a system that are capable of appropriately restricting set actions, and may have the following configuration.

(1) A method that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action, the users including a specific user (e.g., a SP user and a distribution user) for whom an action to be restricted (e.g., a NG word) is configurable, the method comprising a step of, when the action to be restricted is received from any one of a plurality of computers operated by a plurality of users having a specific relationship that does not satisfy a special condition (e.g., relevance) with the specific user (e.g., during distribution of a first mode of content, YES in step S14 of FIG. 8), performing a process for reflecting the action to be restricted in the plurality of computers (e.g., step S20 of FIG. 8), and when the action to be restricted is received from any one of a plurality of computers operated by a plurality of users having a specific relationship that satisfies the special condition (e.g., during distribution of a second mode of content, YES in step S34 of FIG. 10), performing a process for restricting reflection of the action to be restricted (e.g., step S37 of FIG. 10), regardless of whether the specific user is included in the plurality of users.

With this configuration, the action to be restricted is reflected among a plurality of users who have a specific relationship that does not satisfy the special condition on the specific user, while reflection of the action to be restricted is restricted among a plurality of users who have a specific relationship that satisfies the special condition on the specific user, regardless of whether the specific user is included. This enables appropriate restriction of the reflection of the action to be restricted.

(2) In the above (1), the specific relationship that satisfies the special condition includes a relationship in which it is predetermined that the specific user is included among the plurality of users having the specific relationship (e.g., in a second mode of content or a third mode of content, in which a related SP user appears and distributes the content initiatively).

This configuration prevents reflection of an action to be restricted before the specific user is included.

(3) In the above (1), the specific relationship that satisfies the special condition includes a relationship that is predetermined to be related to the specific user (e.g., in a second mode of content or a third mode of content, a related SP user themselves does not appear, but fans of the related SP user gather for communication).

This configuration prevents reflection of an action to be restricted if there is a specific relationship that is predetermined to be related to a specific user.

(4) In the above (1), the special condition includes a first special condition (e.g., SP user A, a SP user belonging to SP1) and a second special condition (e.g., SP user B, a SP user belonging to SP2), and the action to be restricted (e.g., type-specific NG or individual NG) is different between among multiple users having a specific relationship that satisfies the first special condition and among multiple users having a specific relationship that satisfies the second special condition (e.g., FIG. 7B and FIG. 7C).

This configuration allows the action to be restricted to be appropriately varied depending on the special condition.

(5) In the above (1), the specific relationship is a relationship associated with a common group (e.g., see FIG. 6A to FIG. 6C).

This configuration makes it possible to restrict the reflection of actions to be restricted among computers operated by the users associated with a common group.

(6) In the above (1), the specific relationship is a relationship in which a character corresponding to a user (e.g., a user character) is placed within a predetermined range in the virtual space (e.g., see (2) in <Modification Examples>).

This configuration makes it possible to restrict the reflection of actions to be restricted among computers operated by the users whose characters are placed in a predetermined range of the virtual space.

(7) In the above (1), the action includes a comment.

When a comment received from any one of a plurality of computers operated by a plurality of users having a specific relationship that does not satisfy the special condition contains a restriction message (e.g., a default NG common to all users) that is predetermined as a message whose reflection is restricted, the method comprises a step of performing a process of restricting reflection of the restriction message in the comment and reflecting the comment other than the restriction message in the plurality of computers (e.g., step S22 in FIG. 8), and in the step of restricting the reflection of the action to be restricted, when a comment including a message to be restricted set as the action to be restricted is received from one of a plurality of computers operated by a plurality of users each having the specific relationship that satisfies the special condition, a process is performed to restrict the reflection of the comment including the message to be restricted (e.g., if YES in step S17 of FIG. 8, the received comment itself is not reflected).

With this configuration, for a restriction message, the comment other than the restriction message can be reflected, whereas for a message to be restricted, the reflection of a comment itself that includes the message to be restricted can be restricted. This restricts the reflection of a predefined restriction message to a minimum extent, and thus prevents inconveniences such as a failure to carry on the conversation because reflection of a comment that contains a restriction message that the specific user has not specified as a restriction target is restricted.

(8) In the above (1), the action includes a comment.

In the step of restricting reflection, when a comment received from any one of a plurality of computers operated by a plurality of users each having a specific relationship that satisfies the special condition contains a message to be restricted set as the action to be restricted, and when the specific user is not included in the plurality of users, a process is performed to restrict reflection of the message to be restricted in the comment and to reflect the comment other than the message to be restricted in the plurality of computers (e.g., in step S37 of FIG. 10, if either the default NG of the type of the related SP user or the individual NG of the related SP user is included in the comment specified from the comment posting information, and if the related SP user is not actually participating, the process similar to steps S21 to S22 of FIG. 8 is performed to reflect a comment with the part of message corresponding to the NG word replaced with a symbol, for example, and the process proceeds to step S44), and when the specific user is included in the plurality of users, a process for restricting the reflection of the comment including the message to be restricted is performed (e.g., if it is determined in step S37 of FIG. 10 that either the default NG of the type of the related SP user or the individual NG of the related SP user is included in the comment specified from the comment posting information, and if the related SP user is actually participating the content, the process proceeds to step S44 without reflecting the comment itself).

This configuration makes it possible to vary the degree of restriction, depending on whether the specific user is included in the plurality of users having a specific relationship that satisfies a special condition.

(9) In the above (1), a user other than a specific user (e.g., general user) also is allowed to set an action whose reflection is to be restricted only among a plurality of users who have a specific relationship that satisfies a special condition (e.g., relevance) on the user, and
only among a plurality of users having a specific relationship that satisfies a special condition on a first user different from a specific user, when an action to be restricted set by the first user is received from any one of the plurality of computers, the method comprises a step of performing a process to restrict reflection of the action to be restricted (see, (3) in <Modification Examples>, for example).

This configuration prevents the reflection of the action to be restricted that is set for a user other than the specific user from being overly restricted even when the special condition related to that user is not satisfied.

(10) The above (1) comprises:
a step of receiving candidate information (e.g., NG word setting application) that enables identification of a candidate for a new action to be restricted (e.g., a NG word candidate) in response to an operation from the specific user; and
a step of, when the candidate based on the received candidate information is approved by an operator, setting the candidate as an action to be restricted for the specific user (e.g., setting by the NG setting unit 253).

This allows the action approved by the operator to be set as an action to be restricted, which prevents the use of too many actions to be restricted.

(11) In the above (1), the action to be restricted includes: a first action (e.g., a default NG common to all users) with respect to which the user who performed the action is informed that reflection is restricted when the reflection is restricted, and a second action (e.g., individual NG) with respect to which the user is not informed that reflection is restricted, and
in response to performing a process of restricting the reflection of the first action by the step of restricting the reflection of the action to be restricted, the method comprises a step of making a notification to the computer operated by the user who performed the first action to notify that the reflection of the first action is restricted (e.g., if YES in step S38 in FIG. 10, see step S23 in FIG. 8).

With this configuration, in response to the restriction of reflection of a first action included in the action to be restricted, the user is notified that the reflection is restricted. This suppresses the user to repeatedly perform the first action.

(12) In the above (1), the plurality of computers, upon receiving an action, reflect the action in a computer that received the action, regardless of whether the action is an action to be restricted, and output action information that specifies the action (e.g., comment posting information) (e.g., see FIG. 11E, for example), and
in the step of restricting the reflection, when the action based on the action information is not an action to be restricted, action reflection information is output to reflect the action in the plurality of computers, while when the action is an action to be restricted, the action reflection information (e.g., comment information) is not output (see, for example, FIG. 11F).

This configuration prevents the user who performed the action from being able to know whether the action was actually reflected, and thus prevents the user from specifying the action to be restricted and performing an action in a way that circumvents the restriction.

(13) In the above (1), the specific user is defined to belong to one of a plurality of types,
for the plurality of types, a common action to be restricted is set in advance for each type (see, for example, FIG. 7B), and
in the step of restricting the reflection, when a plurality of specific users are included in the plurality of users having the specific relationship, a process may be performed to restrict reflection based not on an action to be restricted set by each of the plurality of specific users but based on a common action to be restricted set in advance for the types to which the plurality of specific users belong (e.g., steps S36 and S43, for example in FIG. 10).

This configuration prevents the number of actions reflected from becoming too small among multiple users who have a specific relationship that satisfies the condition on the plurality of specific users.

(14) In the above (1), when a specific user is included in the plurality of users having a specific relationship, the action by the specific user may be different from the action that another user different from the specific user is allowed to take (e.g., when a user participates as a distribution user, they are not allowed to post a comment. They are allowed to move a SP user's character and output sound within the virtual space, like the SP user's avatar).

This configuration makes the actions that can be taken by a specific user and other users different, allowing each user to take an action appropriate to their situation.

(15) A system that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) for whom an action to be restricted (e.g., a NG word) is configurable,
the system comprising a computer configured to
when the action to be restricted is received from any one of a plurality of computers operated by a plurality of users having a specific relationship that does not satisfy a special condition (e.g., relevance) on the specific user (e.g., during distribution of a first mode of content, YES in step S14 of FIG. 8), perform a process for reflecting the action to be restricted in the plurality of computers (e.g., step S20 of FIG. 8), and when the action to be restricted is received from any one of a plurality of computers operated by a plurality of users having a specific relationship that satisfies the special condition (e.g., during distribution of a second mode of content, YES in step S34 of FIG. 10), perform a process for restricting reflection of the action to be restricted (e.g., step S37 of FIG. 10), regardless of whether the specific user is included in the plurality of users.

With this configuration, the action to be restricted is reflected among a plurality of users who have a specific relationship that does not satisfy the special condition on the specific user, while reflection of the action to be restricted is restricted among a plurality of users who have a specific relationship that satisfies the special condition on the specific user, regardless of whether the specific user is included. This enables appropriate restriction of the reflection of the action to be restricted.

### Addendum 2

The service described in Addendum 1 has been available. A user who takes actions that a certain distributor has set as undesirable tends to be more likely to take actions that have also been set as a restriction target against other distributors who have something in common with the distributor (e.g., other distributors of the same type) than against other distributors who have nothing in common with the distributor. Conventional services, however, do not attempt to make effective use of information about a user who has taken actions set by a certain distributor.

In view of the above, the present invention described in the above embodiment and modified examples provides a method and a system that are capable of effectively using the information on a user who takes an action set as a restriction target, and may have the following configuration.

(1) A method that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) belonging to a first type, the specific user being a user for whom an action to be restricted (e.g., a NG word) is configurable,
the method comprising: a step of, when an action to be restricted set by a first specific user among specific users belonging to the first type is received from any one of a plurality of computers operated by a plurality of users having a specific relationship that satisfies a special condition on the first specific user, restricting reflection of the action to be restricted (e.g., if YES in step S37 of FIG. 10);
a step of specifying restriction information (e.g., NG-related information) for each user who performed the action to be restricted among a plurality of users having a specific relationship that satisfies a special condition on the first specific user (e.g., step S44 in FIG. 10); and
a step of, when a prohibited user who satisfies a prohibition condition according to the restriction information is included in the plurality of users having a specific relationship that satisfies the special condition on any of the specific users belonging to the first type, and when an action is accepted from the computer operated by the prohibited user, restricting reflection of the action, regardless of whether the action is an action to be restricted, and regardless of whether the first specific user is included in the plurality of users (e.g., YES in step S35 of FIG. 10).

This configuration utilizes the restriction information for each of a plurality of users having a specific relationship that satisfies a special condition on the first specific user for a plurality of users having a specific relationship that satisfies the special condition on any specific user belonging to the same first type as the first specific user, and thus restricting an action from a prohibited user who satisfies the prohibition condition according to the restriction information.

(2) In the above (1), users include a specific user belonging to a second type,
and the method comprises a step of, when the prohibited user is included among multiple users having a specific relationship that satisfies a special condition on a second specific user among specific users belonging to the second type, and when an action is received from a computer operated by the prohibited user, if a prohibition condition is not satisfied according to restriction information among the plurality of users having a specific relationship that satisfies a special condition on any specific user belonging to the second type, enabling the action to be reflected on a plurality of computers operated by each of the plurality of users (e.g., NO in step S35 of FIG. 10).

This configuration prevents the restriction information for each user of multiple users who have a specific relationship that satisfies a special condition on the first specific user from being used for a restriction among a plurality of users who have a specific relationship that satisfies a special condition on any of the specific users belonging to a second type different from the first type, thereby preventing excessive restrictions of the reflection.

(3) The above (1) comprises
a step of, in response to a situation in which the prohibited user becomes included in a plurality of users having a specific relationship that satisfies a special condition on the second specific user, informing the second specific user of information that enables identification of the first specific user that caused the prohibited user to satisfy the prohibition condition (see, for example, (4) in <Modification Examples>).

This configuration calls the attention of the second specific user.

(4) The above (1) comprises a step of, in response to a situation in which the prohibited user becomes included in a plurality of users having a specific relationship that satisfies a special condition on the second specific user, informing the second specific user of information that enables identification of the action to be restricted that caused the prohibited user to satisfy the prohibition condition (see, for example, (4) in <Modification Examples>).

This configuration calls the attention of the second specific user.

(5) The above (1) comprises:
a step of identifying restriction information for each user who performed the action to be restricted among a plurality of users having a specific relationship that satisfies a special condition on the second specific user; and
a step of, when an action is received from a computer operated by the prohibited user who performs an action to be restricted among a plurality of users having a specific relationship that satisfies a specific condition on the second specific user to satisfy a prohibition condition in accordance with restriction information, and thus satisfies prohibition conditions for a predetermined number of types, restricting reflection of the action also among a plurality of users having a specific relationship that satisfies a special condition on a specific user belonging to a type with respect to which the user has not yet satisfied the prohibition condition (see, for example, (4) in <Modification Examples>).

This configuration identifies the prohibited user as clearly malicious if the user satisfies prohibition conditions for the predetermined number of types, and prevents an action by this prohibited user from being reflected, regardless of the type of specific user. This prevents the damage from spreading.

(6) The above (1) comprises
a step of lifting the prohibition condition among a plurality of users having a specific relationship that satisfies a special condition on a specific user belonging to the first type, in response to a cancelation operation from the first specific user who caused the prohibited user to satisfy the prohibition condition (see, for example, (4) in <Modification Examples>).

This configuration prevents a situation in which the prohibited user satisfies the prohibition condition continuously, and thus the action from this prohibited user is continuously restricted.

(7) In the above (1), the specific relationship is a relationship associated with a common group (e.g., see FIG. 6A to FIG. 6C).

This configuration makes it possible to restrict the reflection of actions to be restricted among computers operated by the users associated with a common group.

(8) In the above (1), the specific relationship is a relationship in which a character corresponding to a user (e.g., a user character) is placed within a predetermined range in the virtual space (e.g., see (2) in <Modification Examples>).

This configuration makes it possible to restrict the reflection of actions to be restricted among computers operated by the users whose characters are placed in a predetermined range of the virtual space.

(9) In the above (1), the action includes a comment.

When a comment received from any one of a plurality of computers operated by a plurality of users having a specific relationship that does not satisfy the special condition contains a restriction message (e.g., a default NG common to all users) that is predetermined as a message whose reflection is restricted, the method comprises a step of performing a process of restricting reflection of the restriction message in the comment and of reflecting the comment other than the restriction message in the plurality of computers (e.g., step S22 in FIG. 8), and
in the step of restricting the reflection of the action to be restricted, when a comment including a message to be restricted set as the action to be restricted is received from one of a plurality of computers operated by a plurality of users each having the specific relationship that satisfies the special condition, a process is performed to restrict the reflection of the comment including the message to be restricted (e.g., if YES in step S17 of FIG. 8, the received comment itself is not reflected).

With this configuration, for a restriction message, the comment other than the restriction message can be reflected, whereas for a message to be restricted, the reflection of a comment itself that includes the message to be restricted can be restricted. This restricts the reflection of a predefined restriction message to a minimum extent, and thus prevents inconveniences such as a failure to carry on the conversation because reflection of a comment that contains a restriction message that the specific user has not specified as a restriction target is restricted.

(10) In the above (1), the action includes a comment.

In the step of restricting reflection, when a comment received from any one of a plurality of computers operated by a plurality of users each having a specific relationship that satisfies the special condition contains a message to be restricted set as the action to be restricted, and when the specific user is not included in the plurality of users, a process is performed to restrict reflection of the message to be restricted in the comment and to reflect the comment other than the message to be restricted in the plurality of computers (e.g., in step S37 of FIG. 10, if either the default NG of the type of the related SP user or the individual NG of the related SP user is included in the comment specified from the comment posting information, and if the related SP user is not actually participating, the process similar to steps S21 to S22 of FIG. 8 is performed to reflect a comment with the part of message corresponding to the NG word replaced with a symbol, for example, and the process proceeds to step S44), and when the specific user is included in the plurality of users, a process for restricting the reflection of the comment including the message to be restricted is performed (e.g., if it is determined in step S37 of FIG. 10 that either the default NG of the type of the related SP user or the individual NG of the related SP user is included in the comment specified from the comment posting information, and if the related SP user is actually participating the content, the process proceeds to step S44 without reflecting the comment itself).

This configuration makes it possible to vary the degree of restriction, depending on whether the specific user is included in the plurality of users having a specific relationship that satisfies a special condition.

(11) In the above (1), a user other than a specific user (e.g., general user) also is allowed to set an action whose reflection is to be restricted only among a plurality of users who have a specific relationship that satisfies a special condition (e.g., relevance) on the user, and
only among a plurality of users having a specific relationship that satisfies a special condition on a first user different from a specific user, when an action to be restricted set by the first user is received from any one of a plurality of computers, a process is performed to restrict reflection of the action to be restricted (see, (3) in <Modification Examples>, for example).

This configuration prevents the reflection of the action to be restricted that is set for a user other than a specific user from being overly restricted even when the special condition related to that user is not satisfied.

(12) The above (1) comprises:
a step of receiving candidate information (e.g., NG word setting application) that enables identification of a candidate for a new action to be restricted (e.g., a NG word candidate) in response to an operation from the specific user; and
a step of, when the candidate based on the received candidate information is approved by an operator, setting the candidate as an action to be restricted for the specific user (e.g., setting by the NG setting unit 253).

This allows the action approved by the operator to be set as an action to be restricted, which prevents the use of too many actions to be restricted.

(13) In the above (1), the action to be restricted includes: a first action (e.g., a default NG common to all users) that informs the user who performed the action that reflection is restricted when the reflection is restricted, and a second action (e.g., individual NG) that does not inform the user that reflection is restricted, and
in response to processing of restricting the reflection of the first action by the step for restricting the reflection of the action to be restricted, a notification is made so that the reflection of the first action is restricted on the computer operated by the user who performed the first action (e.g., if YES in step S38 in FIG. 10, see step S23 in FIG. 8).

With this configuration, in response to the restriction of reflection of a first action included in the action to be restricted, the user is notified that the reflection is restricted. This suppresses the user to repeatedly perform such a first action.

(14) In the above (1), the plurality of computers, upon receiving an action, reflect the action in a computer that received the action, regardless of whether the action is an action to be restricted, and output action information that identifies the action (e.g., comment posting information) (e.g., see FIG. 11E, for example),
in the step of restricting the reflection, when the action based on the action information is not an action to be restricted in the second situation, action reflection information is output to reflect the action in the plurality of computers, while when the action is an action to be restricted, the action reflection information (e.g., comment information) is not output (see, for example, FIG. 11F).

This configuration prevents the user who performed the action from being able to know whether the action was actually reflected, and thus prevents the user from specifying the action to be restricted and performing an action in a way that circumvents the restriction.

(15) In the above (1), the specific user is defined to belong to one of a plurality of types,
for the plurality of types, an action to be restricted is set for each type (see, for example, FIG. 7B), and
in the step of restricting the reflection, when a plurality of specific users are included in the plurality of users having the specific relationship, a process may be performed to restrict reflection based not on an action to be restricted set by each of the plurality of specific users but based on a common action to be restricted set in advance for the types to which the plurality of specific users belong (e.g., steps S36 and S43, for example in FIG. 10).

This configuration prevents the number of actions reflected from becoming too small among multiple users who have a specific relationship that satisfies the condition on the plurality of specific users.

(16) In the above (1), when a specific user is included in the plurality of users having a specific relationship, the action by the specific user may be different from the action that another user different from the specific user is allowed to take (e.g., when a user participates as a distribution user, they are not allowed to post a comment. They are allowed to move a SP user's character and output sound within the virtual space, like the SP user's avatar).

This configuration makes the actions that can be taken by a specific user and other users different, allowing each user to take an action appropriate to their situation.

(17) A system allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) belonging to a first type, the specific user being a user for whom an action to be restricted (e.g., a NG word) is configurable,
the system comprising a computer configured to perform:
a process of, when an action to be restricted set by a first specific user among specific users belonging to the first type is received from any one of a plurality of computers operated by a plurality of users having a specific relationship that satisfies a special condition on the first specific user, restricting reflection of the action to be restricted (e.g., if YES in step S37 of FIG. 10);
a process of specifying restriction information (e.g., NG-related information) for each user who performed the action to be restricted among a plurality of users having a specific relationship that satisfies a special condition on the first specific user (e.g., step S44 in FIG. 10); and
a process of, when a prohibited user who satisfies a prohibition condition according to the restriction information is included in the plurality of users having a specific relationship that satisfies the special condition on any of the specific users belonging to the first type, and when an action is accepted from the computer operated by the prohibited user, restricting reflection of the action, regardless of whether the action is an action to be restricted, and regardless of whether the first specific user is included in the plurality of users (e.g., YES in step S35 of FIG. 10).

This configuration utilizes the restriction information for each of a plurality of users having a specific relationship that satisfies a special condition on the first specific user for a plurality of users having a specific relationship that satisfies the special condition on any specific user belonging to the same first type as the first specific user, and thus restricting an action from a prohibited user who satisfies the prohibition condition according to the restriction information.

### Addendum 3

The service described in Addendum 1 has been available. Note that distributors who have something in common (e.g., distributors of the same type) tend to share their undesirable actions. The conventional service, however, requires each distributor to set an action to be restricted, which causes unnecessary time and effort, and may not be able to properly restrict the actions.

In view of the above, the present invention described in the above embodiment and modified examples provides a method and a system that are capable of properly restricting actions without causing unnecessary time and effort, and may have the following configuration.

(1) A method that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including specific users (e.g., a SP user and a distribution user), the specific users being a user for whom an action to be restricted (e.g., a NG word) is configurable, the specific users including a specific user (e.g., SP1) belonging to a first type and a specific user (e.g., SP2) belonging to a second type, the method comprising:
a step of, when from any of a plurality of computers operated by each of a plurality of users having a specific relationship that satisfies a special condition on any specific user, receiving an action to be restricted set by the specific user, restricting reflection of the action to be restricted (e.g., if YES in step S37 of FIG. 10),
the action to be restricted preset for the specific user includes a different action for each of a specific user belonging to the first type and a specific user belonging to the second type (see, for example, FIG. 7B).

This configuration presets an action to be restricted that is a different action between a specific user belonging to the first type and a specific user belonging to the second type. This allows appropriate restriction of actions according to the type without the trouble in setting actions to be restricted.

(2) The above (1) comprises
a step of setting a new action to be restricted that is an action in response to an operation from the specific user (e.g., setting by the NG setting unit 253), in which
the setting step does not allow changing of settings to exclude an action to be restricted preset for the specific user from restriction (see, for example, (5) in <Modification Examples>).

This configuration makes it possible to set an action to be restricted in response to an operation by a specific user, and thus allows the setting to be customized according to the SP user's intention, thus improving the convenience. Note that this does not allow a preset action to be restricted to be changed, thus making it easier for the operator to manage the preset action to be restricted.

(3) The above (1) comprises
a step of setting a new action to be restricted that is an action in response to an operation from the specific user (e.g., setting by the NG setting unit 253), in which
the setting step also allows a setting change to make an action to be restricted that has been preset for the specific user non-restricted (see, for example, (5) in <Modification Examples>).

This configuration makes it possible to set an action to be restricted in response to an operation by a specific user, and also allows to change a preset action to be restricted, thus allowing the specific user to customize the setting according to their intention and improving the convenience.

(4) In the above (1), the step of restricting the reflection allows, when a plurality of users having the specific relationship include a specific user belonging to the first type and a specific user belonging to the second type, to perform a process to restrict reflection based on an action to be restricted that is different from an action to be restricted set by each of the plurality of specific users (e.g., if YES in step S36, determination is made in step S43).

This configuration makes it possible to make the process for restricting the reflection different depending on whether multiple related SP users are included.

(5) In the above (1), the specific relationship is a relationship associated with a common group (e.g., see FIG. 6A to FIG. 6C).

This configuration makes it possible to restrict the reflection of actions to be restricted among computers operated by the users associated with a common group.

(6) In the above (1), the specific relationship is a relationship in which a character corresponding to a user (e.g., a user character) is placed within a predetermined range in the virtual space (e.g., see (2) in <Modification Examples>).

This configuration makes it possible to restrict the reflection of actions to be restricted among computers operated by the users whose characters are placed in a predetermined range of the virtual space.

(7) In the above (1), the action includes a comment.

When a comment received from any one of a plurality of computers operated by a plurality of users having a specific relationship that does not satisfy the special condition contains a restriction message (e.g., a default NG common to all users) that is predetermined as a message whose reflection is restricted, the method comprises a step of performing a process of restricting reflection of the restriction message in the comment and of reflecting the comment other than the restriction message in the plurality of computers (e.g., step S22 in FIG. 8), and
in the step of restricting the reflection of the action to be restricted, when a comment including a message to be restricted set as the action to be restricted is received from one of a plurality of computers operated by a plurality of users each having the specific relationship that satisfies the special condition, a process is performed to restrict the reflection of the comment including the message to be restricted (e.g., if YES in step S17 of FIG. 8, the received comment itself is not reflected).

With this configuration, for a restriction message, the comment other than the restriction message can be reflected, whereas for a message to be restricted, the reflection of a comment itself that includes the message to be restricted can be restricted. This restricts the reflection of a predefined restriction message to a minimum extent, and thus prevents inconveniences such as a failure to carry on a conversation because reflection of a comment that contains a restriction message that the specific user has not specified as a restriction target is restricted.

(8) In the above (1), the action includes a comment.

In the step of restricting reflection, when a comment received from any one of a plurality of computers operated by a plurality of users each having a specific relationship that satisfies the special condition contains a message to be restricted set as the action to be restricted, and when the specific user is not included in the plurality of users, a process is performed to restrict reflection of the message to be restricted in the comment and to reflect the comment other than the message to be restricted in the plurality of computers (e.g., in step S37 of FIG. 10, if either the default NG of the type of the related SP user or the individual NG of the related SP user is included in the comment specified from the comment posting information, and if the related SP user is not actually participating, the process similar to steps S21 to S22 of FIG. 8 is performed to reflect a comment with the part of message corresponding to the NG word replaced with a symbol, for example, and the process proceeds to step S44), and when the specific user is included in the plurality of users, a process for restricting the reflection of the comment including the message to be restricted is performed (e.g., if it is determined in step S37 of FIG. 10 that either the default NG of the type of the related SP user or the individual NG of the related SP user is included in the comment specified from the comment posting information, and if the related SP user is actually participating the content, the process proceeds to step S44 without reflecting the comment itself).

This configuration makes it possible to vary the degree of restriction, depending on whether the specific user is included in the plurality of users having a specific relationship that satisfies a special condition.

(9) In the above (1), a user other than a specific user (e.g., general user) also is allowed to set an action whose reflection is to be restricted only among a plurality of users who have a specific relationship that satisfies a special condition (e.g., relevance) on the user, and
only among a plurality of users having a specific relationship that satisfies a special condition on a first user different from a specific user, when an action to be restricted set by the first user is received from any one of a plurality of computers, a process is performed to restrict reflection of the action to be restricted (see, (3) in <Modification Examples>, for example).

This configuration prevents the reflection of the action to be restricted that is set for a user other than the specific user from being overly restricted even when the special condition related to that user is not satisfied.

(10) The above (1) comprises:
a step of receiving candidate information (e.g., NG word setting application) that enables identification of a candidate for a new action to be restricted (e.g., a NG word candidate) in response to an operation from the specific user; and
a step of, when the candidate based on the received candidate information is approved by an operator, setting the candidate as an action to be restricted for the specific user (e.g., setting by the NG setting unit 253).

This allows the action approved by the operator to be set as an action to be restricted, which prevents the use of too many actions to be restricted.

(11) In the above (1), the action to be restricted includes: a first action (e.g., a default NG common to all users) with respect to which the user who performed the action is informed that reflection is restricted when the reflection is restricted, and a second action (e.g., individual NG) with respect to which the user is not informed that reflection is restricted, and
in response to processing of restricting the reflection of the first action by the step for restricting the reflection of the action to be restricted, a notification is made so that the reflection of the first action is restricted on the computer operated by the user who performed the first action (e.g., if YES in step S38 in FIG. 10, see step S23 in FIG. 8).

With this configuration, in response to the restriction of reflection of a first action included in the action to be restricted, the user is notified that the reflection is restricted. This suppresses the user to repeatedly perform such a first action.

(12) In the above (1), the plurality of computers, upon receiving an action, reflect the action in a computer that received the action, regardless of whether the action is an action to be restricted, and output action information that specifies the action (e.g., comment posting information) (e.g., see FIG. 11E, for example), and
in the step of restricting the reflection, when the action based on the action information is not an action to be restricted, action reflection information is output to reflect the action in the plurality of computers, while when the action is an action to be restricted, the action reflection information (e.g., comment information) is not output (see, for example, FIG. 11F).

This configuration prevents the user who performed the action from being able to know whether the action was actually reflected, and thus prevents the user from specifying the action to be restricted and performing an action in a way that circumvents the restriction.

(13) In the above (1), the specific user is defined to belong to one of a plurality of types,
for the plurality of types, a common action to be restricted is set in advance for each type (see, for example, FIG. 7B), and
in the step of restricting the reflection, when a plurality of specific users are included in the plurality of users having the specific relationship, a process may be performed to restrict reflection based not on an action to be restricted set by each of the plurality of specific users but based on a common action to be restricted set in advance for the types to which the plurality of specific users belong (e.g., steps S36 and S43, for example in FIG. 10).

This configuration prevents the number of actions reflected from becoming too small among multiple users who have a specific relationship that satisfies the condition on the plurality of specific users.

(14) In the above (1), when a specific user is included in the plurality of users having a specific relationship, the action by the specific user may be different from the action that another user different from the specific user is allowed to take (e.g., when a user participates as a distribution user, they are not allowed to post a comment, This allows the SP user terminal to operate the user character of the SP user in the virtual space as if it were the avatar of the SP user.

This configuration makes the actions that can be taken by a specific user and other users different, allowing each user to take an action appropriate to their situation.

(15) A system that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including specific users (e.g., a SP user and a distribution user), the specific users being a user for whom an action to be restricted (e.g., a NG word) is configurable, the specific users including a specific user (e.g., SP1) belonging to a first type and a specific user (e.g., SP2) belonging to a second type,
the system comprising a computer configured to perform
a process of, when from any of a plurality of computers operated by each of a plurality of users having a specific relationship that satisfies a special condition on any specific user, receiving an action to be restricted set by the specific user, restricting reflection of the action to be restricted (e.g., if YES in step S37 of FIG. 10),
the action to be restricted preset for the specific user includes a different action for a specific user belonging to the first type and a specific user belonging to the second type (see, for example, FIG. 7B).

This configuration presets an action to be restricted that is a different action between a specific user belonging to the first type and a specific user belonging to the second type. This allows appropriate restriction of actions according to the type without the trouble in setting actions to be restricted.

### Addendum 4

The service described in Addendum 1 has been available. The conventional service, however, assumes only one virtual space for one piece of content. Thus, if a plurality of virtual spaces are set for one piece of content, this service may fail to restrict actions appropriately.

In view of the above, the present invention described in the above embodiment and modified examples provides a method and a system that are capable of properly restricting actions in accordance with the distribution state, and may have the following configuration.

(1) A method that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) for whom an action to be restricted (e.g., a NG word) is configurable,
the specific relationship includes a plurality of types of specific relationships (e.g., content of a third aspect, see FIG. 6C) as specific relationships in which a special condition related to the specific user is satisfied at a predetermined timing,
the method comprises: a step of reflecting an action received from a plurality of computers operated by a plurality of users having a specific relationship that is selected by the specific user from the plurality of types of specific relationships, on the plurality of computers (see, for example, step S62 of FIG. 12);
a step of reflecting an action received from a plurality of computers operated by a plurality of users having a specific relationship that is not selected by the specific user from the plurality of types of specific relationships, on the plurality of computers (see, for example, step S62 of FIG. 12); and
a step of, when receiving the action to be restricted from any of a plurality of computers operated by each of a plurality of users having a specific relationship among the plurality of types of specific relationships, restricting reflection of the action to be restricted, regardless whether the specific relationship is of a type selected by the specific user (e.g., if YES in step S59 of FIG. 12).

This configuration enables, when multiple types of specific relations are included as specific relations for which a special condition for a specific user is satisfied at a predetermined timing, understanding of actions among multiple users having the type of specific relationship selected by the specific user. This prevents actions from becoming complicated and making it difficult for the specific user to understand them, and also restricts an action to be restricted, regardless of whether the action is performed among multiple users who have the specific relationship of the type selected by the specific user.

(2) The above (1) comprises
a step of performing a process to enable a character corresponding to the specific user to be displayed on any computer operated by a user having any of the plurality of types of specific relationship, regardless of whether the type of specific relationship is the type selected by the specific user (e.g., step S54 in FIG. 12; in the case of live event content, for example, in all of the multiple rooms corresponding to the content, the user character is displayed).

This configuration allows the multiple users having the multiple types of specific relationship to recognize and check the character corresponding to the specific user.

(3) The above (1) comprises
a step of performing a process to enable a character corresponding to the specific user to be displayed only on a plurality of computers operated by a plurality of users having a specific relationship selected by the specific user among the plurality of types of specific relationship (e.g., step S54 in FIG. 12; in the case of fan social gathering content, for example, in the room finally selected by the specific performer, the user character is displayed).

This increases the sense of anticipation for the display of the character corresponding to the specific user.

(4) The above (1) comprises:
a step of provisionally selecting a type of a specific relationship in response to an operation by the specific user;
a step of finally selecting the type of the specific relationship that was provisionally selected in the provisional selection step, in response to an operation by the specific user; and
a step of specifying, on a computer operated by the specific user, a history of actions reflected in a plurality of computers operated by a plurality of users having a specific relationship of the type provisionally selected in the provisional selection step (e.g., step S55 of FIG. 12),
in the step of performing a process to enable display, while a provisional selection is made in the provisional selection step, the character is not displayed on a plurality of computers operated by a plurality of users having the provisionally selected specific relationship, and the character is displayed after a final selection is made in the final selection step (e.g., step S54 in FIG. 12).

This configuration allows the specific user to check the actions reflected among the plurality of users who have a specific relationship of the provisionally selected type before the character is displayed, and to understand the state of the actions to use it as a reference for, for example, whether or not to make a final selection.

(5) In the above (1), in the provisional selection step, a type of specific relationship having a number of users having the specific relationship equal to or greater than a predetermined number is selected as a default.

This configuration makes it easier for the specific user to understand the level of interaction and excitement among the plurality of users having the provisionally selected specific relationship, based on the status of reflected actions, for example.

(6) The above (1) comprises
a step of changing the type of the selected specific relationship in response to an operation from the specific user.

This configuration allows the specific user to change the types of specific relationship to be checked one after another, thereby improving the convenience of the specific user.

(7) In the above (1), the specific relationship is a relationship associated with a common group (e.g., see FIG. 6A to FIG. 6C).

This configuration makes it possible to restrict the reflection of actions to be restricted among computers operated by the users associated with a common group.

(8) In the above (1), the specific relationship is a relationship in which a character corresponding to a user (e.g., a user character) is placed within a predetermined range in the virtual space (e.g., see (2) in <Modification Examples>).

This configuration makes it possible to restrict the reflection of actions to be restricted among computers operated by the users whose characters are placed in a predetermined range of the virtual space.

(9) In the above (1), the action includes a comment.

When a comment received from any one of a plurality of computers operated by a plurality of users having a specific relationship that does not satisfy the special condition contains a restriction message (e.g., a default NG common to all users) that is predetermined as a message whose reflection is restricted, the method comprises a step of performing a process of restricting reflection of the restriction message in the comment and of reflecting the comment other than the restriction message in the plurality of computers (e.g., step S22 in FIG. 8), and
in the step of restricting the reflection of the action to be restricted, when a comment including a message to be restricted set as the action to be restricted is received from one of a plurality of computers operated by a plurality of users each having the specific relationship that satisfies the special condition, a process is performed to restrict the reflection of the comment including the restriction message (e.g., if YES in step S17 of FIG. 8, the received comment itself is not reflected).

With this configuration, for a restriction message, the comment other than the restriction message can be reflected, whereas for a message to be restricted, the reflection of a comment itself that includes the message to be restricted can be restricted. This restricts the reflection of a predefined restriction message to a minimum extent, and thus prevents inconveniences such as a failure to carry on the conversation because reflection of a comment that contains a restriction message that the specific user has not specified as a restriction target is restricted.

(10) In the above (1), the action includes a comment.

In the step of restricting reflection, when a comment received from any one of a plurality of computers operated by a plurality of users each having a specific relationship that satisfies the special condition contains a message to be restricted set as the action to be restricted, and when the specific user is not included in the plurality of users, a process is performed to restrict reflection of the message to be restricted in the comment and to reflect the comment other than the message to be restricted in the plurality of computers (e.g., in step S37 of FIG. 10, if either the default NG of the type of the related SP user or the individual NG of the related SP user is included in the comment specified from the comment posting information, and if the related SP user is not actually participating, the process similar to steps S21 to S22 of FIG. 8 is performed to reflect a comment with the part of message corresponding to the NG word replaced with a symbol, for example, and the process proceeds to step S44), and when the specific user is included in the plurality of users, a process for restricting the reflection of the comment including the message to be restricted is performed (e.g., if it is determined in step S37 of FIG. 10 that either the default NG of the type of the related SP user or the individual NG of the related SP user is included in the comment specified from the comment posting information, and if the related SP user is actually participating the content, the process proceeds to step S44 without reflecting the comment itself).

This configuration makes it possible to vary the degree of restriction, depending on whether the specific user is included in the plurality of users having a specific relationship that satisfies a special condition.

(11) In the above (1), a user other than a specific user (e.g., general user) also is allowed to set an action whose reflection is to be restricted only among a plurality of users who have a specific relationship that satisfies a special condition (e.g., relevance) on the user, and
only among a plurality of users having a specific relationship that satisfies a special condition on a first user different from a specific user, when an action to be restricted set by the first user is received from any one of a plurality of computers, a process is performed to restrict reflection of the action to be restricted (see, (3) in <Modification Examples>, for example).

This configuration prevents the reflection of the action to be restricted that is set for a user other than the specific user from being overly restricted even when the special condition related to that user is not satisfied.

(12) The above (1) comprises:
a step of receiving candidate information (e.g., NG word setting application) that enables identification of a candidate for a new action to be restricted (e.g., a NG word candidate) in response to an operation from the specific user; and
a step of, when the candidate based on the received candidate information is approved by an operator, setting the candidate as an action to be restricted for the specific user (e.g., setting by the NG setting unit 253).

This allows the action approved by the operator to be set as an action to be restricted, which prevents the use of too many actions to be restricted.

(13) In the above (1), the action to be restricted includes: a first action (e.g., a default NG common to all users) that informs the user who performed the action that reflection is restricted when the reflection is restricted, and a second action (e.g., individual NG) that does not inform the user that reflection is restricted, and
in response to processing of restricting the reflection of the first action by the step of restricting the reflection of the action to be restricted, the method comprises a step of making a notification to the computer operated by the user who performed the first action to notify that the reflection of the first action is restricted (e.g., if YES in step S38 in FIG. 10, see step S23 in FIG. 8).

With this configuration, in response to the restriction of reflection of a first action included in the action to be restricted, the user is notified that the reflection is restricted. This suppresses the user to repeatedly perform such a first action.

(14) In the above (1), the plurality of computers, upon receiving an action, reflect the action in a computer that received the action, regardless of whether the action is an action to be restricted, and output action information that identifies the action (e.g., comment posting information) (e.g., see FIG. 11E, for example),
in the step of restricting the reflection, when the action based on the action information is not an action to be restricted in the second situation, action reflection information is output to reflect the action in the plurality of computers, while when the action is an action to be restricted, the action reflection information (e.g., comment information) is not output (see, for example, FIG. 11F).

This configuration prevents the user who performed the action from being able to know whether the action was actually reflected, and thus prevents the user from specifying the action to be restricted and performing an action in a way that circumvents the restriction.

(15) In the above (1), the specific user is defined to belong to one of a plurality of types,
for the plurality of types, a common action to be restricted is set in advance for each type (see, for example, FIG. 7B), and
in the step of restricting the reflection, when a plurality of specific users are included in the plurality of users having the specific relationship, a process may be performed to restrict reflection based not on an action to be restricted set by each of the plurality of specific users but based on a common action to be restricted set in advance for the types to which the plurality of specific users belong (e.g., steps S36 and S43, for example in FIG. 10).

This configuration prevents the number of actions reflected from becoming too small among multiple users who have a specific relationship that satisfies the condition on the plurality of specific users.

(16) In the above (1), when a specific user is included in the plurality of users having a specific relationship, the action by the specific user may be different from the action that another user different from the specific user is allowed to take (e.g., when a user participates as a distribution user, they are not allowed to post a comment. This allows the SP user terminal to operate the user character of the SP user in the virtual space as if it were the avatar of the SP user.

This configuration makes the actions that can be taken by a specific user and other users different, allowing each user to take an action appropriate to their situation.

(17) A system that allows an action (e.g., comments, and behavior) received from a plurality of computers operated by a plurality of users who have a specific relationship (e.g., users who participate in a virtual space of the same content, and users whose user characters exist within a predetermined range) to be reflected on the computers so that each user is able to recognize the action,
the users including a specific user (e.g., a SP user and a distribution user) for whom an action to be restricted is configurable, the action to be restricted being an action whose reflection is restricted (e.g., a NG word),
the specific relationship including a plurality of types of specific relationships (e.g., content of a third aspect, see FIG. 6C) as specific relationships in which a special condition related to the specific user is satisfied at a predetermined timing.
the system comprising a computer configured to perform:
a process of reflecting an action received from a plurality of computers operated by a plurality of users having a specific relationship that is selected by the specific user from the plurality of types of specific relationships, on the plurality of computers (see, for example, step S62 of FIG. 12);
a process of reflecting an action received from a plurality of computers operated by a plurality of users having a specific relationship that is not selected by the specific user from the plurality of types of specific relationships, on the plurality of computers (see, for example, step S62 of FIG. 12); and
a process of, when receiving the action to be restricted from any of a plurality of computers operated by each of a plurality of users having a specific relationship among the plurality of types of specific relationships, restricting reflection of the action to be restricted, regardless whether the specific relationship is of a type selected by the specific user (e.g., if YES in step S59 of FIG. 12).

This configuration enables, when multiple types of specific relations are included as specific relations for which a special condition for a specific user is satisfied at a predetermined timing, understanding of actions among multiple users having the type of specific relationship selected by the specific user. This prevents actions from becoming complicated and making it difficult for the specific user to understand them, and also restricts an action to be restricted, regardless of whether the action is performed among multiple users who have the specific relationship of the type selected by the specific user.

The embodiments disclosed in this description are to be considered in all respects as illustrative and not restrictive. The scope of the present invention is defined by the claims, rather than the above description, and is intended to include any modification within the meaning and scope equivalent to the terms of the claims.

### REFERENCE SIGNS LIST

1 Communication system, 2 Network, 100 Distribution server, 200 Administrator terminal, 300 User terminal, 400 Distribution user terminal

What is claimed is:

1. A method that allows an action received from a plurality of computers operated by a plurality of users who have a specific relationship to be reflected on the computers so that each user is able to recognize the action,
the users including a specific user for whom an action to be restricted is configurable, the action to be restricted being an action whose reflection is restricted,
the method comprising a step of, in a first situation where the specific user is not included in the plurality of users having the specific relationship, even when the action to be restricted is received from one of the plurality of computers, performing a process of reflecting the action to be restricted on the plurality of computers, and when a situation changes from the first situation to a second situation where the specific user is included, and when the action to be restricted is received from one of the plurality of computers, performing a process of restricting reflection of the action to be restricted.

2. The method according to claim 1, further comprising: a step of updating a history of actions received from the plurality of computers operated by the plurality of users having the specific relationship; and
a step of, when a new user becomes included in the plurality of users having the specific relationship, outputting history information that enables identification of history of actions updated by the updating step to a computer operated by the new user, wherein
when the new user is the specific user and a situation changes from the first situation to the second situation, and when the history of actions includes an action to be restricted, the updating step enables updating so that the history of actions includes actions other than the action to be restricted.

3. The method according to claim 2, wherein the action to be restricted includes an action belonging to a first type and an action belonging to a second type, and
in the updating step, when the new user is the specific user and a situation changes from the first situation to the second situation, the history of actions is updated so as to include an action belonging to the first type, and not to include an action belonging to the second type.

4. The method according to claim 2, wherein when the new user is the specific user and the situation changes from the first situation to the second situation, the outputting step outputs history information that enables identification of the history of actions that has been updated by the updating step to the computer operated by the specific user.

5. The method according to claim 1, further comprising a step of, in the second situation, setting a new action to be restricted that is among actions reflected on the plurality of computers, in response to an operation from the specific user.

6. The method according to claim 1, wherein the specific relationship is a relationship associated with a common group.

7. The method according to claim 1, wherein the specific relationship is a relationship in which a character corresponding to a user is placed within a predetermined range in a virtual space.

8. The method according to claim 1, wherein the action includes a comment,
the method further comprising a step of, even in the first situation, when a comment received from one of the plurality of computers contains a restriction message that is predetermined as a message whose reflection is restricted, performing a process of restricting reflection of a part of the restriction message in the comment and of reflecting the comment other than the part of the restriction message on the plurality of computers, and
in the step of performing the process of restricting the reflection of the action to be restricted, when a comment including a message to be restricted set as the action to be restricted is received in the second situation, a process is performed to restrict the reflection of the comment including the message to be restricted.

9. The method according to claim 1, wherein a user other than a specific user also is allowed to set an action to be restricted that is an action whose reflection is to be restricted only among a plurality of users who have a specific relationship that satisfies a special condition on the user, and
only among a plurality of users having a specific relationship that satisfies a special condition on a first user different from a specific user, when an action to be restricted set by the first user is received from any one of the plurality of computers, the method comprises a step of restricting reflection of the action to be restricted.

10. The method according to claim 1 further comprising: a step of receiving candidate information that enables identification of a candidate for a new action to be restricted in response to an operation from the specific user; and
a step of, when the candidate based on the received candidate information is approved by an operator, setting the candidate as an action to be restricted for the specific user.

11. The method according to claim 1, wherein the action to be restricted includes: a first action that informs the user who performed the action that reflection is restricted when the reflection is restricted, and a second action that does not inform the user that reflection is restricted, and
in response to processing of restricting the reflection of the first action by the step of restricting the reflection of the action to be restricted, the method comprises a step of making a notification to the computer operated by the user who performed the first action to notify that the reflection of the first action is restricted.

12. The method according to claim 1, wherein the plurality of computers, upon receiving an action, reflect the action in a computer that received the action, regardless of whether the action is an action to be restricted, and output action information that identifies the action, and
in the step of restricting the reflection, when the action based on the action information is not an action to be restricted in the second situation, action reflection information is output to reflect the action in the plurality of computers, while when the action is an action to be restricted, the action reflection information is not output.

13. The method according to claim 1, wherein the specific user is defined to belong to one of a plurality of types,
for the plurality of types, a common action to be restricted is set in advance for each type, and
in the step of restricting the reflection, when a plurality of specific users are included in the plurality of users having the specific relationship in the second situation, a process may be performed to restrict reflection based not on an action to be restricted set by each of the plurality of specific users but based on a common action to be restricted set in advance for the types to which the plurality of specific users belong.

14. The method according to claim 1, wherein when a specific user is included in the plurality of users having a specific relationship, the action by the specific user is different from the action that another user different from the specific user is allowed to take.

15. A system that allows an action received from a plurality of computers operated by a plurality of users who have a specific relationship to be reflected on the computers so that each user is able to recognize the action, the users including a specific user for whom an action to be restricted is configurable, the action to be restricted being an action whose reflection is restricted,
the system comprising a computer configured to
in a first situation where the specific user is not included in the plurality of users having the specific relationship, even when the action to be restricted is received from one of the plurality of computers, perform a process of reflecting the action to be restricted on the plurality of computers, and when a situation changes from the first situation to a second situation where the specific user is included, and when the action to be restricted is received from one of the plurality of computers, perform a process of restricting reflection of the action to be restricted.
